(19) United States
(12) Patent Application Publication
(10) Pub. No.: US 2016/0172063 A9
(43) Pub. Date: Jun. 16, 2016

(54) RADIATION SHIELDING DEVICE

(71) Applicant: Enrique Pizarro, New York, NY (US)

(72) Inventor: Enrique Pizarro, New York, NY (US)

(21) Appl. No.: 13/962,938

(22) Filed: Aug. 8, 2013

Related U.S. Application Data
(60) Provisional application No. 61/746,547, filed on Dec. 27, 2012.

(51) Int. Cl. G21F 3/00

(52) U.S. Cl. CPC G21F 3/00

(57) ABSTRACT

A new and improved radiation shielding device is disclosed. The shielding device has applications in medical imaging procedures where the device can be used to protect sensitive organs from unnecessary exposure to radiation. Various features of the device include its light weight, smaller size, composition, and significantly greater flexibility in use than traditional radiation shields. The device may be constructed for a number of different applications and radiation intensities. The shielding device may be used to protect male, female, adult, and pediatric patients in various ways Innovative methods of using, and positioning, the device are also disclosed.

### FIELD OF INVENTION

This invention relates to a shielding device used to reduce or eliminate radiation absorbed by patients during medical imaging procedures.

### BACKGROUND

Prior to the discovery of x-rays, physicians were severely limited in their ability to diagnose and treat various ailments. Without being able to examine the internal structure of the human body, physicians had to rely on limited diagnostic methods such as a conversation with the patient, visual inspection, physical inspection, and their prior experience. Most doctor visits begin with a short conversation about what ails the patient, which some patients are able to articulate and others are not. Further, patients may have some clues about the cause of discomfort, but may not be able to pinpoint the problem to a specific location on their body. Moreover, some patients arrive at the hospital unable to discuss their trauma with the physician—which may be due to an extreme medical condition such as gunshot wounds or coma, or due to developmental problems which leave the patient unable to comprehend their surroundings or express their thoughts.

Visual inspection, while in most cases easily performed by a physician, is limited to visible cues of damage to a human body. With certain examples of extreme trauma, such as a severed limb or an open fracture, a visual inspection can provide a significant amount of information about the trauma. With other trauma, however, where structural damage is less apparent, such as a closed fracture with minimal displacement, a visual inspection is unlikely to provide a satisfactory diagnosis. A doctor may also see signs of trauma, such as a hematoma, but will need more information about why the hematoma appeared.

A doctor may also perform a physical inspection, which may occur in response to assertions of pain by the patient. Thus, in response to a patient saying “my arm hurts here,” a physician may press on the arm in several locations, and ask the patient to bend or twist the arm, in an effort to isolate location of the pain. In combination with a physician's knowledge and experience, patient clues, visual, and physical inspections may provide some information about the patient's discomfort, but images of internal organs and body structures, such as the skeleton, are usually preferred when dealing with serious trauma.

The discovery of x-rays ushered in a new era of advances in medical science. Physicians were no longer constrained to inadequate inspection techniques, and were now able to obtain images of physical trauma affecting their patients that were not available without x-rays. Due to their ability to penetrate skin and other tissue, x-rays can been used to detect, for example, fractures, broken bones, heart disease, calcium deposits, cancer, and lung infections, among many other uses.

However, x-ray technology came with a price. In order to penetrate human tissue, x-ray (and other medical imaging) machines emit ionizing radiation, which in many instances is powerful enough to cause damage to human tissue and organs. One possible side-effect of ionizing radiation, if uncontrolled, is an increased possibility of various cancers. In medical applications, x-ray machines emit a beam toward the human organ to be imaged, but the beam may cover more than just the desired area. In that case, other organs have been exposed to potentially damaging electromagnetic radiation. One solution to protect other organs from radiation is the radiation shield. Generally, radiation shields are designed to prevent electromagnetic radiation from passing through, or at the very least to attenuate the resulting electromagnetic waves.

Previously available radiation shielding devices possess a number of negative attributes, including a high acquisition cost, high replacement cost, unadaptability to various radiographical requirements, imprecise protection of sensitive organs, and unnecessarily large size and weight. Accordingly, there exists a need for a device without those shortcomings. It is therefore one object of the present invention to provide a radiation shielding device adaptable to shield a patient from harmful radiation during one or more medical examinations without the drawbacks of the previously available shielding systems.

### SUMMARY

In one embodiment of the present invention, a radiation shield capable of protecting various body organs from radiation is disclosed. The radiation shield may comprise a body with one or more extending members. The geometry of the radiation shield and its members enables precise shielding of male and female reproductive organs. The radiation shield is useful for both adult and pediatric patients. The geometry and construction of the device renders a larger garment with extending members as compared with smaller gonadal shields, enhancing its usability, availability, and reducing the likelihood of being lost. The extending members of the radiation shield may be sized differently to provide greater flexibility in applications of the shield to cover the radiosensitive organs of different age groups.

In another embodiment of the present invention, the radiation shielding device may be adapted to withstand radiation of varying intensity. Methods of manufacturing and constructing the device, including its internal and external structure are also disclosed herein. In another embodiment of the present invention, methods of use of the radiation shielding device to protect patients from unnecessary or excessive exposure to radiation are disclosed.

### BRIEF DESCRIPTION OF THE DRAWINGS

FIG. 1 illustrates one possible arrangement of an x-ray room in a hospital or clinic.

FIG. 2 illustrates one embodiment of a shielding device in accordance with the present invention from a perspective view.

FIG. 3 illustrates the shielding device from FIG. 1 with the strap in an open position.

FIG. 4 illustrates a front view of the shielding device from FIG. 1.

FIG. 5 illustrates a back view of the shielding device from FIG. 1.

FIG. 6 illustrates a top view of the shielding device from FIG. 1.

FIG. 7 illustrates a bottom view of the shielding device from FIG. 1.

FIG. 8 illustrates a left view of the shielding device from FIG. 1.

FIG. 9 illustrates a right view of the shielding device from FIG. 1.

FIG. 10 illustrates a back view of another embodiment of the shielding device.

FIG. 11 illustrates a front view of the shielding device from FIG. 10.

FIG. 12A illustrates some dimensions of the shielding device in the preferred embodiment.

FIG. 12B illustrates additional dimensions of the shielding device in the preferred embodiment.

FIG. 12C illustrates other dimensions of the shielding device in the preferred embodiment.

FIG. 12D illustrates some angular dimensions of the shielding device in the preferred embodiment.

FIG. 13A illustrates a cross-sectional view of one embodiment of the shielding device.

FIG. 13B illustrates a cross-sectional view of another embodiment of the shielding device.

FIG. 14A illustrates a cross-sectional view of one embodiment of attached layers of the shielding device.

FIG. 14B illustrates a cross-sectional view of another embodiment of attached layers of the shielding device.

FIG. 15A illustrates a cross-sectional view of one embodiment of the multiple attached layers of the shielding device.

FIG. 15B illustrates a cross-sectional view of another embodiment of the multiple attached layers of the shielding device.

FIG. 16A illustrates one embodiment of the edge strip of the shielding device.

FIG. 16B illustrates another embodiment of the edge strip of the shielding device.

FIG. 17 illustrates an anterior, or front, view of the shielding device in the preferred embodiment.

FIG. 18 illustrates a posterior, or back, view of the shielding device in the preferred embodiment.

FIG. 19 illustrates preferred positioning of the shielding device in the Supralay Position.

FIG. 20 is a sample x-ray image illustrating one example of the shielding device in the Supralay Position.

FIG. 21 illustrates preferred positioning of the shielding device in the Modified Supralay Position.

FIG. 22 is a sample x-ray image illustrating one example of the shielding device in the Modified Supralay Position.

FIG. 23 illustrates preferred positioning of the shielding device in the Bilasupralay Position.

FIG. 24 is a sample x-ray image illustrating one example of the shielding device in the Bilasupralay Position.

FIG. 25 illustrates preferred positioning of the shielding device in the Male Pediatric Infralay Position.

FIG. 26 is a sample x-ray image illustrating one example of the shielding device in Male Pediatric Infralay Position.

FIG. 27 illustrates preferred positioning of the shielding device in the Adult Infralay Position.

FIG. 28 is a sample x-ray image illustrating one example of the shielding device in the Adult Infralay Position.

FIG. 29 illustrates preferred positioning of the shielding device as a half-apron for pediatric AP chest x-rays.

FIG. 30 illustrates preferred positioning of the shielding device as a half-apron for adult PA x-rays.

FIG. 31 illustrates preferred positioning of the shielding device as a half-apron for adult lateral chest x-rays.

FIG. 32 illustrates preferred positioning of the shielding device in the Modified Infralay Position.

FIG. 33 is a sample x-ray image illustrating one example of the shielding device in the Modified Infralay Position.

### DETAILED DESCRIPTION

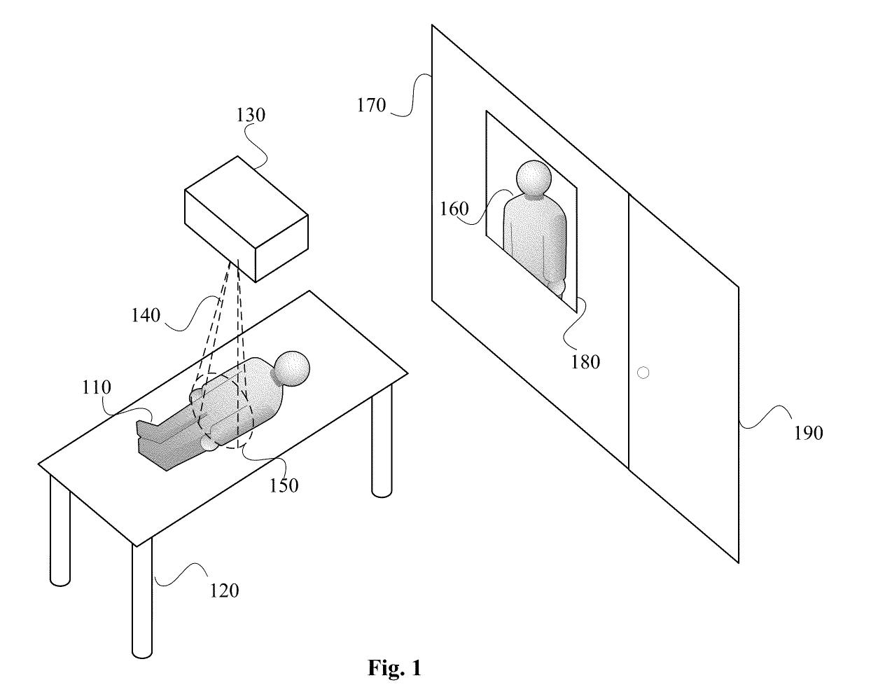

FIG. 1 illustrates one possible arrangement of an x-ray room in a hospital or clinic. Examination table 120 is used to support patients in lying or sitting positions. X-ray machine 130 generates the electromagnetic beam 140 that is used to obtain x-ray images. In this example, x-ray machine 130 is positioned above examination table 120, but in many configurations x-ray machine 130 is movable in various directions and axis, to be able to capture images from different vantage points and directions. Some x-ray machines are mounted on a movable and rotatable arm, while others are more stationary, depending on the applications.

In FIG. 1, the equipment is managed by x-ray technician 160, positioned behind shielded wall 170, with a preferably shielded window 180. In order to adjust the position of x-ray machine 130, or patient 110, x-ray technician 160 opens preferably shielded door 190 and walks into the x-ray room. In this example, the x-ray technician is interested in taking an x-ray picture of the patient's abdomen. The technician therefore places patient 110 in a lying position on table 120, and walks into the x-ray control room. Once x-ray technician 160 is behind the shielded wall 170, he or she activates x-ray machine 130, which generates an x-ray beam 140 toward patient 110. Although technician 160 intends to take an x-ray image of the abdomen only, the beam 140 would cover an area 150, which includes other important organs of patient 110, such as the reproductive system. The exposure of various organs of patient 110 would create unnecessary short and long-term health risks for patient 110. These hazards can be avoided by applying various embodiments of the present invention.

### External Construction

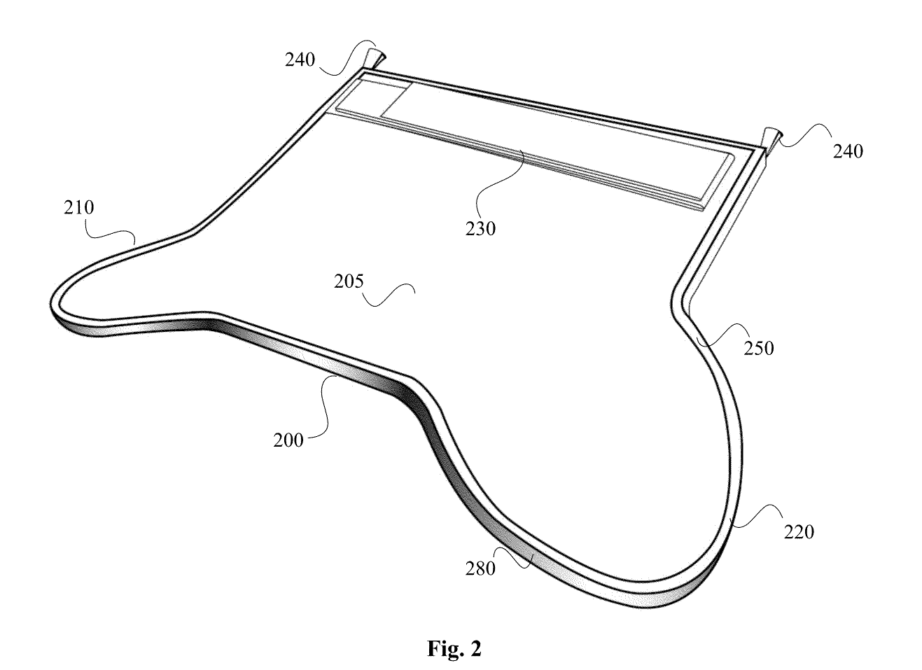

FIG. 2 illustrates one embodiment of the present invention, also referred to as a shielding device, or apron, herein, from a perspective view. As illustrated, apron 200 comprises a relatively rectangular center portion 205, and two extending shielding members 210 and 220 lying in the same plane as the center portion 205. In some embodiments, center portion 205 may deviate slightly from a rectangular shape, and may, for example, take on some trapezoidal characteristics. Shielding member 210 may be referred to as the smaller shield, and shielding member 220 may be referred to as the larger shield. Shielding device 200 also includes a strap 230, which is used to fix the device on a patient. Loops 240, attached to the top of shielding device 200, can be used to secure the device in storage, or to hang it on a wall. In this embodiment, strip 250, shown as surrounding the edge of shielding device 200 along the perimeter, is used as a structural component in order to fix the various components of the device together, such as external and internal layers of materials, and maintain them in the same configuration throughout use. Shielding device 200 may have a depth 280, the size of which varies depending on the materials composing the device and methods of construction thereof

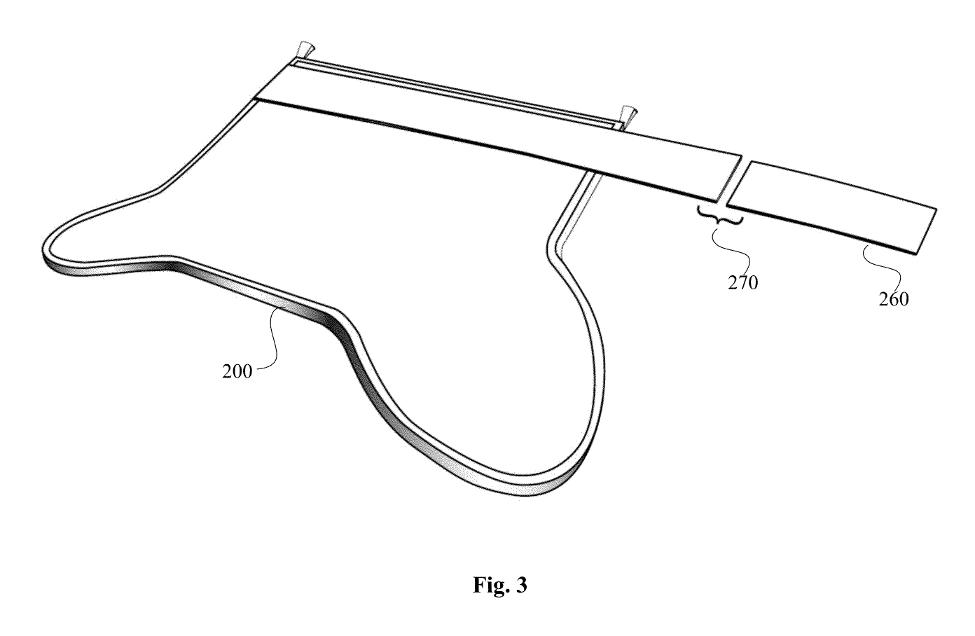

FIG. 3 illustrates the shielding device 200 of FIG. 1, with strap 230 in the extended position. Gap 270 is used to illustrate the variable length of strap 230, which can be made longer or shorter, depending on the anticipated size of patients and applications. Strap 230 may be of a static length, pre-configured during manufacture, or it may be of an extendible length. Strap 230 may be extended by providing a sliding buckle, or other type of an extension mechanism recognized by one of ordinary skill in the art. In one embodiment, tail end 260 of strap 230 wraps around the waist of the patient in order to secure the shielding device.

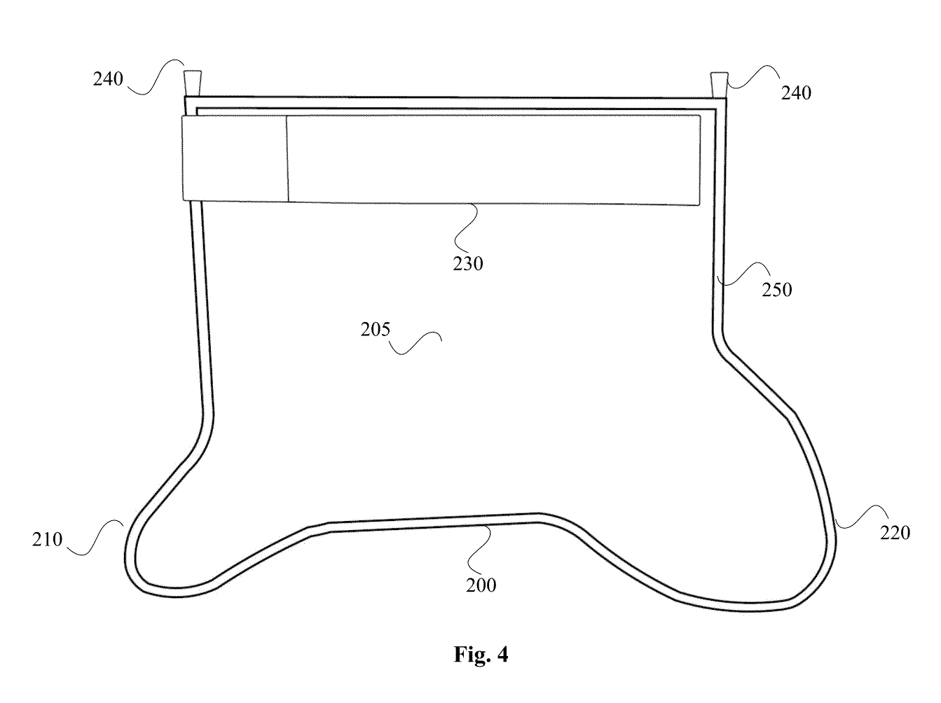

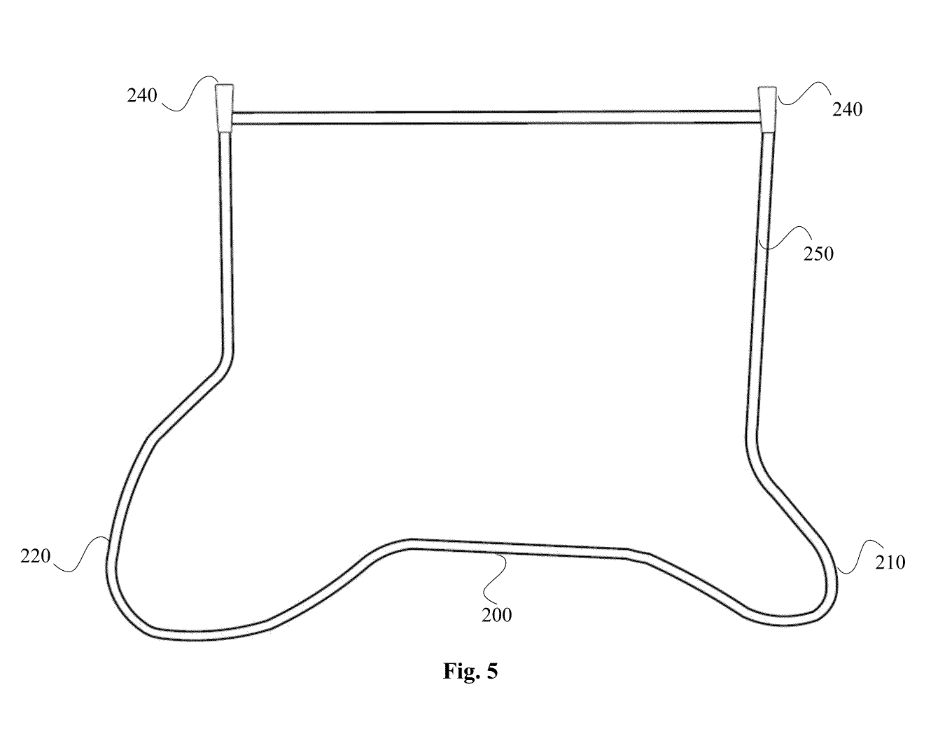

FIG. 4 illustrates the front view of shielding device 200, comprising the elements identified in FIG. 1, including center portion 205, extending shielding members 210 and 220, strap 230, loops 240, and structural strip 250. FIG. 5 is a back view of shielding device 200, illustrating the same elements as FIG. 4, except strap 230. In other embodiments, strap 230 may appear on the back of the device, which would make it appear in FIG. 5, or on both sides of the device. One of ordinary skill in the art would recognize that depending on the application, strap 230 can be placed at other positions and angles of shielding device 200.

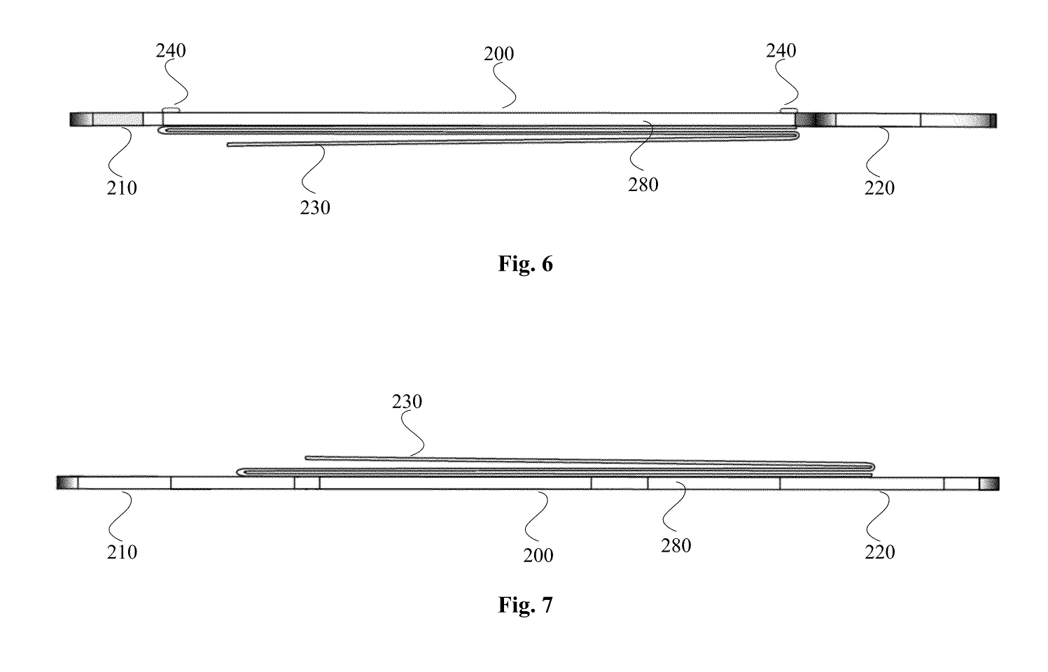

In FIG. 6, shielding device 200 is shown from the top view. Elements 210, 220, 230, 240, and 280 are illustrated in this figure. The central portion 205 is not visible in this view. Depth 280 illustrated in FIG. 6 is substantially similar to depth 280 from FIG. 1. In this embodiment, depth 280 is covered by structural strip 250. In other embodiments, structural strip 250 is not a necessary element of the shielding device.

In FIG. 7, apron 200 is shown from the bottom view. Elements 210, 220, and 230 are also illustrated in this figure. As in FIG. 6, central portion 290 is not visible in this view. Depth 280 illustrated in FIG. 7 is substantially similar to depth 280 from FIG. 1. In this embodiment, depth 280 is covered by structural strip 250. In other embodiments, structural strip 250 is not a necessary element of the shielding device.

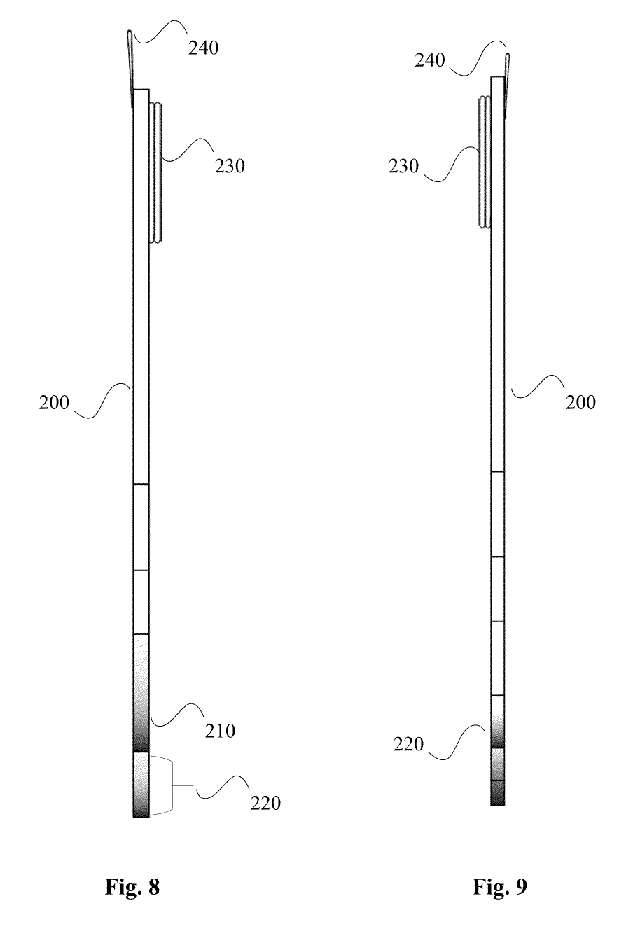

FIG. 8 shows a left view of shielding device 200 from FIG. 1, and FIG. 9 shows a right view of the shielding device. Although FIGS. 8 and 9 are side views of the device, and do not show the three-dimensional aspects of extension members 210 and 220, the members are shown in their general position as viewed from the side. Further, since in this embodiment shielding member 220 is larger than shielding member 210, member 220 can be seen protruding beyond element 210 in FIG. 8. Strap 230 and loops 240 are the same elements as described in FIG. 1 and accompanying text.

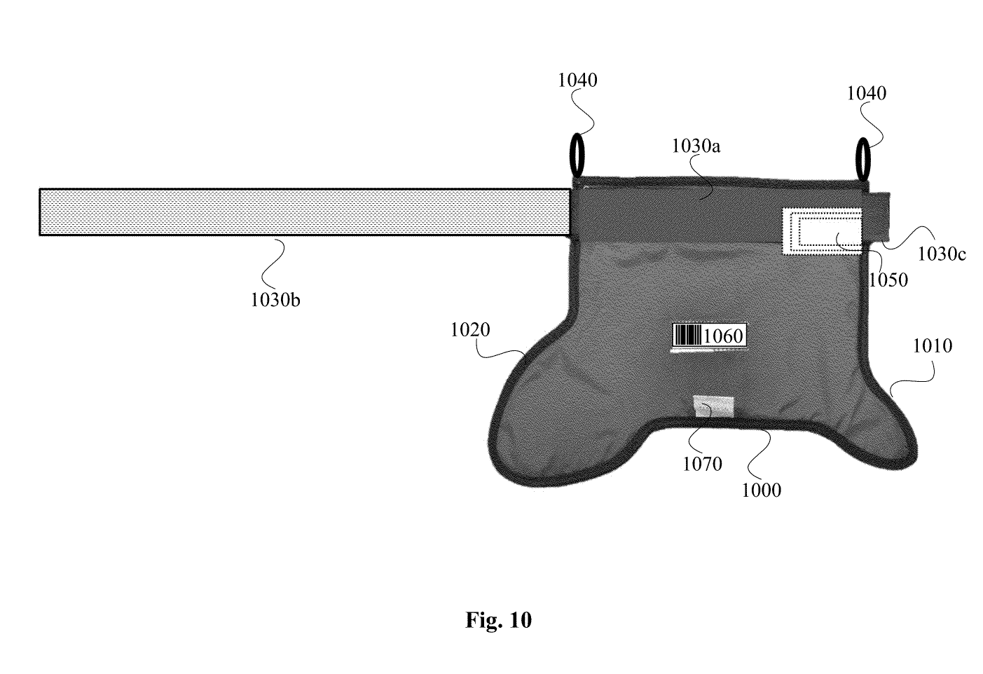

FIG. 10 illustrates another embodiment of the shielding device. In this embodiment and figure, the shielding device is labeled 1000, comprising a central portion, and extending shielding members 1010 and 1020, which are similar to members 210 and 220 shown in FIG. 1. Here, strap 1030 is divided into two components, 1030a and 1030b. 1030a is a portion of the strap attached to the body of shielding device 1000. Strap 1030b is a portion of strap 1030 that extends beyond the body of device 1000, and wraps around the body of a patient. In some embodiments, strap 1030 may extend beyond both sides of device 1000, as illustrated by strap 1030c, which extends opposite strap 1030b. Loops 1040 are similar to loops 240 from FIG. 1, and are used to store, hang, or fix the shielding device. Shielding device 1000 may also comprise one or more labels 1050 and 1070. These labels may be used to provide instructions, manufacturing, care, and other information to owners and users of the shielding device.

In the embodiment illustrated in FIG. 10, the shielding device also comprises a tracking element 1060. Tracking element 1060 may be a bar code or other identification system that is viewable and understandable by machine or human. Element 1060 may be attached to device 1000, and/or covered by a protective material, which may be see through. Tracking element may also be a form of an electronic tracking device, such as an RFID chip. The tracking element enables hospitals and clinics to know the whereabouts of shielding devices, and under certain circumstances, other information, including the shield user and procedure it was used for.

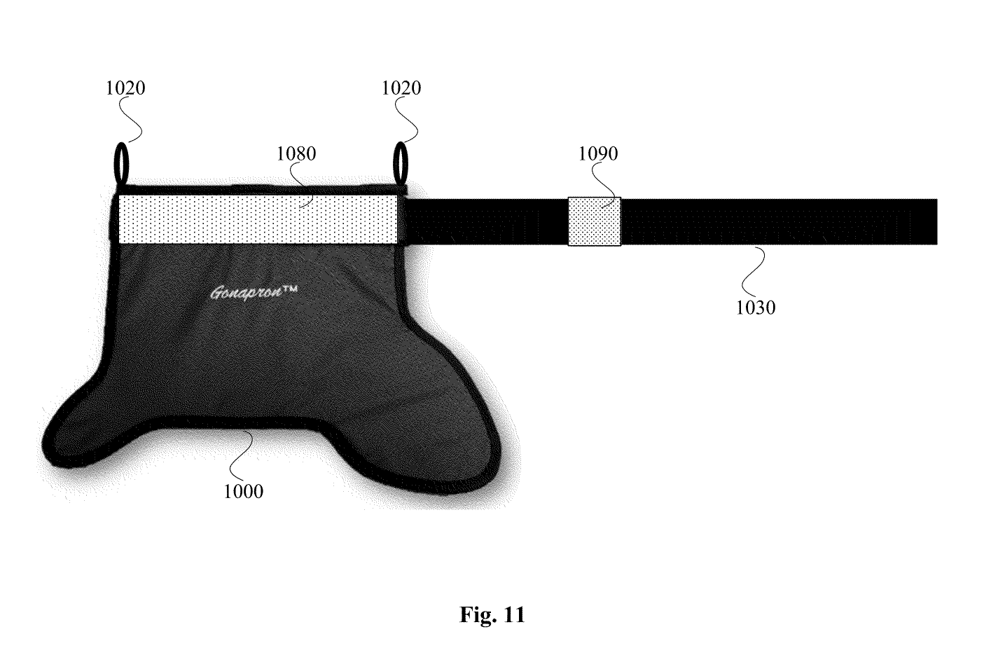

FIG. 11 illustrates a view of shielding device 1000 opposite the side illustrated in FIG. 10. Here, shielding device 1000, strap 1030, and loops 1040 are the same elements described in FIG. 10 and accompanying text. In FIG. 11, device 1000 also comprises attaching strap 1080 and attaching patch 1090. Attaching strap 1080 is used to secure strap 1030 after strap 1030 is wrapped around the patient, preferably at the waist. Patch 1090 may be used to roll up and/or secure strap 1030 when the shield is used in a strapless configuration—in other words, to prevent strap 1030 from being contaminated or interfering with the procedure. In the preferred embodiment, strap 1080 and patch 1090 are made of Velcro, allowing for easy attachment of strap 1030 to the body of shielding device 1000. One of ordinary skill in the art will recognize that other attachment configurations are possible, including clips, buttons, magnets, and other devices.

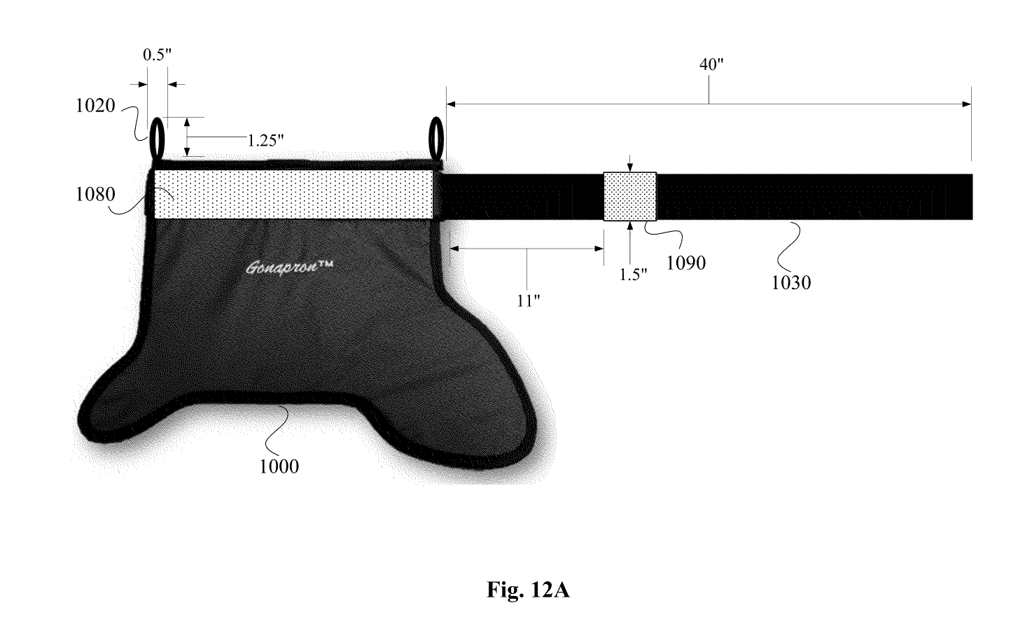

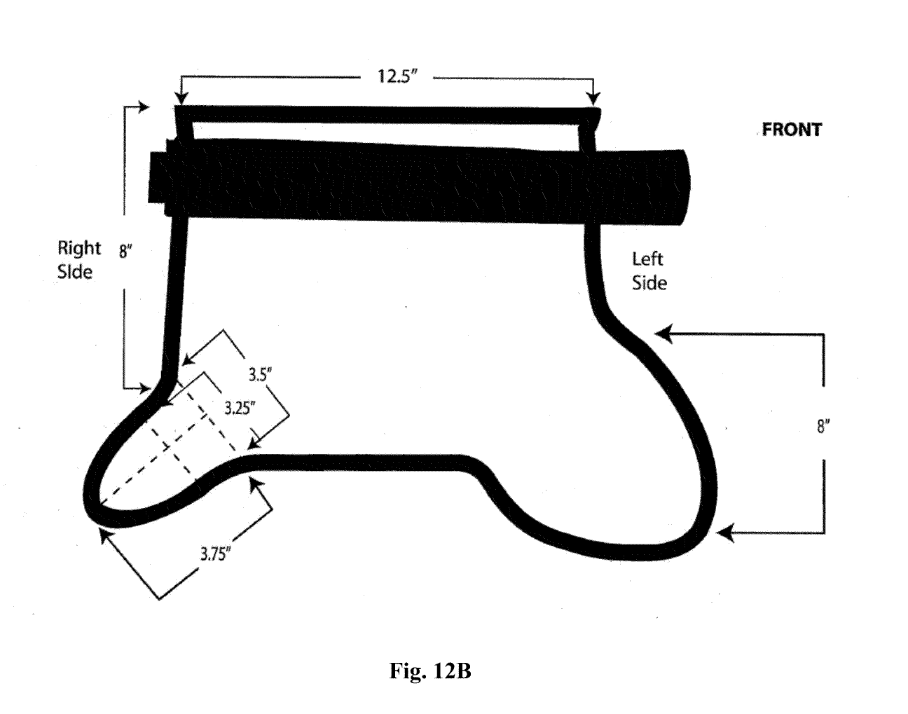

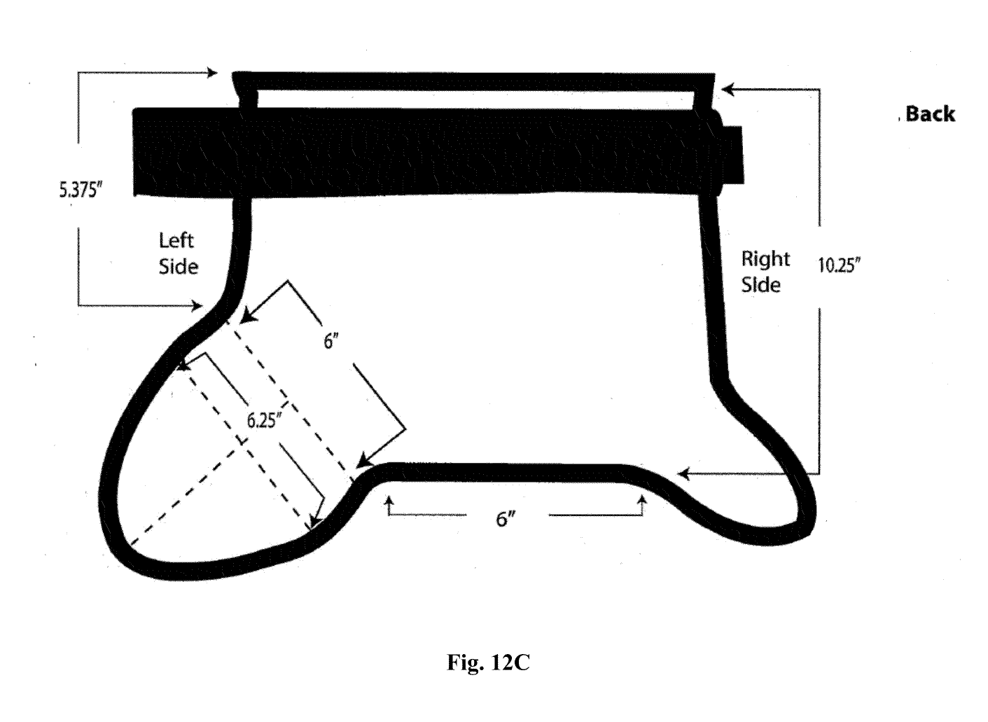

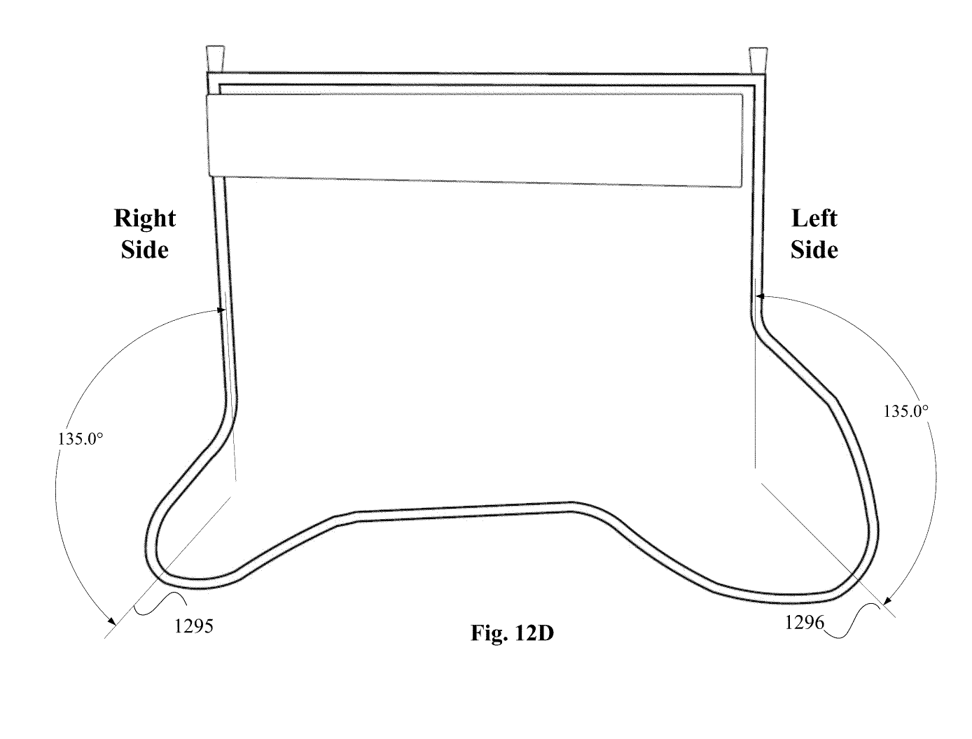

FIGS. 12A-12D illustrate some of the dimensions of the shielding device in the preferred embodiment. The dimensions presented herein are approximate, and can vary due to manufacturing or design choices. In FIG. 12A, the strap 1030 is shown in the unfolded position with a length of 40″ (inches). As illustrated, the width of strap 1030 and patch 1090 is 1.5″, whereas the distance from patch 1090 to the body of the apron is 11″. Loops 1020 have a height of 1.25″ and width of 0.5″ as illustrated.

FIGS. 12B and 12C illustrate dimensions for the body of the apron in the preferred embodiment, and its components. FIG. 12B shows the front view of the apron, and FIG. 12C shows the back view of the apron. For the purpose of maintaining consistency, the “Right Side” and “Left Side” labels in these figures have been assigned to a particular side of the apron. In other words, the label “Right Side” refers to the same side of the apron, regardless of whether the apron is depicted in the front view in FIG. 12B or back view in FIG. 12C. FIG. 12B illustrates the length of the smaller shield (3.75″), its width at the point where the smaller shield begins to taper (3.25″), its width at the point where the smaller shield meets the body of the apron (3.5″), the height of the Right Side (8″), length of the rectangular portion of the apron's body (12.5″), and height of the larger shield as measured at a plane substantially parallel to the Right Side of the apron (8″). FIG. 12C illustrates the height of the Left Side of the substantially rectangular portion of the apron's body (5.375″), the width of the larger shield at the point where the larger shield begins to taper (6.25″), its width at the point where the larger shield meets the body of the apron (6″), the length of the bottom of the rectangular part of the apron (6″), and the height of the rectangular portion of the apron's body (10.25″).

FIG. 12D illustrates the angles of placements of the smaller and larger shields in the preferred embodiment. Angle 1296 is measured from the Left Side of the apron to a line dividing the larger shield in two approximately equal halves longitudinally, and angle 1295 is measured from the Right Side of the apron to a line dividing the smaller shield in two approximately equal halves longitudinally. Both angles are 135° in the preferred embodiment. As noted above, each dimension provided in reference to FIGS. 12A-12D applies to the preferred embodiment of the apron, and one of ordinary skill in the art will understand that the dimensions may be modified to fit appropriate needs. Moreover, imperfections in manufacturing processes may cause deviation from the dimensions outlined above. These dimensions are not provided as a limitation on the invention as a whole, but rather to illustrate the preferred embodiment of the invention.

### Internal Construction

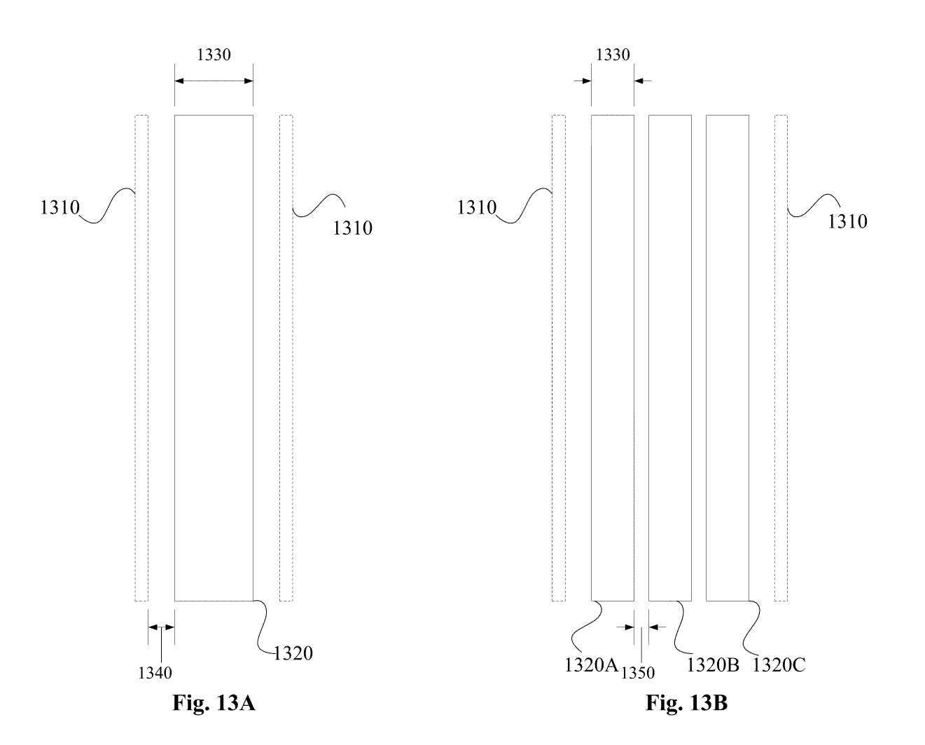

Generally, the internal construction of the shielding device provides flexibility in manufacturing the device to satisfy various shielding requirements and applications. In various embodiments, the shielding device may be constructed to provide more or less shielding, to reduce or increase weight, to increase or decrease durability, or to factor in appropriate costs. FIGS. 13A-16B illustrate various embodiments of the shielding device's internal construction.

FIG. 13A illustrates a cross-sectional view of one embodiment of the present invention. Here, the device comprises three layers of material: two outer layers 1310, and inner layer 1320. In the preferred embodiment, the shielding properties are provided by inner layer 1320, although in other embodiments layers 1310 may contribute to radiation shielding. In the preferred embodiment, outer layers 1310 protect the inner layer 1320 from damage through wear and tear or from environmental damage, such as from water; provide a surface with an easy grip; and provide structural integrity for the shielding device as a whole. To these ends, outer layers 1310 may comprise a waterproof, or at least water resistant, material such as a type of polyester or nylon. One of ordinary skill will recognize that other materials meeting or all some of the criteria outlined above may be used for outer layers 1310.

Inner layer 1320, also referred to as a shielding layer herein, plays a crucial role in the radiation shielding effects of the shielding device. In the preferred embodiment, the inner layer 1320 is a polymer material comprising a fine powder of shielding material homogenously spread throughout the polymer material. The shielding material, or powder, may be lead-based or lead-free. Lead-based shielding materials comprise a certain amount of lead. Lead-free shielding materials may comprise metals, such as cadmium, indium, tin, antimony, cesium, barium, cerium, gadolinium, tungsten, lead, bismuth, silver, nickel, copper, brass, stainless steel, iron, cobalt, chromium, iron, aluminum, titanium, or other materials, such as concrete. To achieve desired shielding characteristics, a combination of the above materials may be used. Thickness 1330 of the shielding layer 1320 may vary depending on the materials used to manufacture the shielding layer, the applications, and other factors such as desired durability and weight. The radiology community at times refers to the shielding characteristics of a particular material as “lead equivalent”—or the equivalent thickness of pure lead required to attain the same shielding effect as the employed material. In the preferred embodiment, the thickness 1330 is between 0.5 mm and 0.75 mm lead equivalent. However, in other embodiments, thickness 1330 may range from 0.25 mm to 1 mm lead equivalent. For specialized applications, thickness 1330 may be lower than 0.25 mm or higher than 1 mm lead equivalent.

Distance 1340 is provided for illustrative purposes in FIG. 13A. In the preferred embodiment, the various layers of the shielding device are firmly pressed against each other so as to create a single shielding device, or apron. Preferably, therefore, the distance 1340 is almost zero. However, depending on the attachment and integration methods discussed below, there may exist a thin space between the various layers, and this is illustrated as distance 1340 in FIG. 13A.

FIG. 13B illustrates a cross-section of a shielding device comprising multiple internal, or shielding, layers 1320, identified as layers 1320A, 1320B, and 1320C. Manufacturing the shielding device with multiple shielding layers enables more efficient manufacturing practices. For example, when manufacturing a 0.75 mm lead equivalent shielding device, the device may comprise three 0.25 mm lead equivalent shielding layers, or one 0.5 mm and one 0.25 mm lead equivalent shielding layers, instead of relying on a single layer. This flexibility reduces manufacturing costs and allows for various combinations of shielding layers. Layers 1320A, 1320B, and 1320C may comprise materials discussed above in reference to layer 1320 from FIG. 13A. An added benefit of a shielding device with multiple shielding layers 1320 is the ability to select different materials for the different layers, thereby expanding the possible shielding characteristics of the device. Width 1330 in FIG. 13B depends on the desired shielding characteristics, similarly to width 1330 from FIG. 13A. Distance 1350 between layers 1320, is preferably close to zero, similarly to distance 1340 from FIG. 13A. One of ordinary skill in the art will recognize that the number of layers, their thickness, and spacing can vary depending on the desired application for the shielding device.

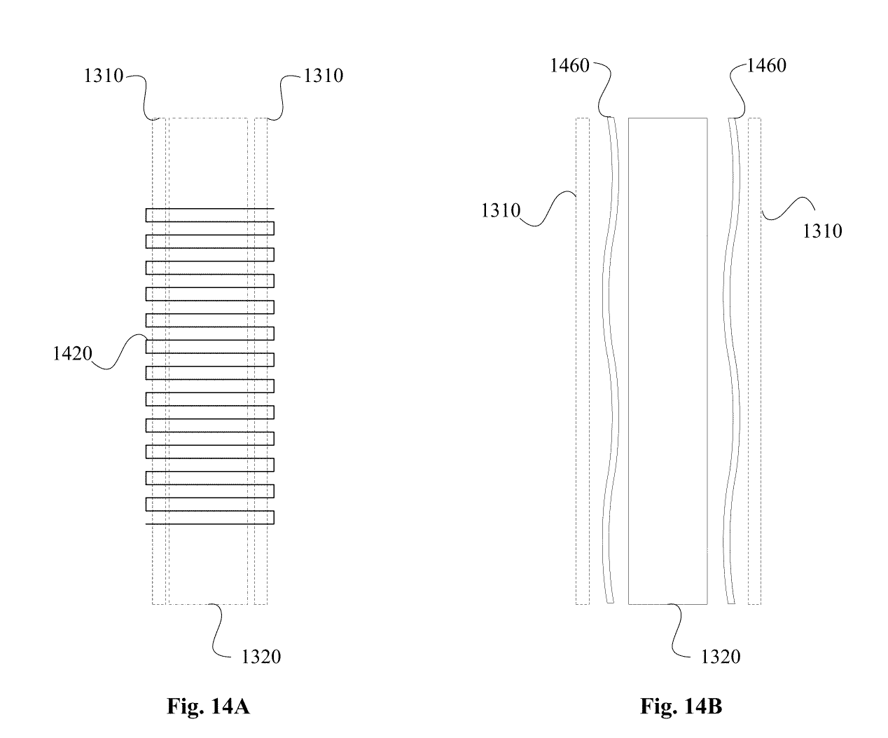

FIGS. 14A and 14B show various methods of attaching the different layers of the shielding device together. FIG. 14A illustrates the preferred embodiment, wherein the outer layers 1310 are stitched together with inner layer 1320 by using a thread 1420. Thread 1420 is preferably made of a heavy duty material capable of withstanding serious wear and tear, such as nylon. One of ordinary skill in the art will recognize that various stitching patterns may be applied. FIG. 14B illustrates an alternative embodiment wherein the various layers are attached by introducing layers of adhesive 1460 between layers 1310 and 1320. In this embodiment, the adhesive material is preferably selected so as to provide for a desired amount of bending and flexibility of the shielding device.

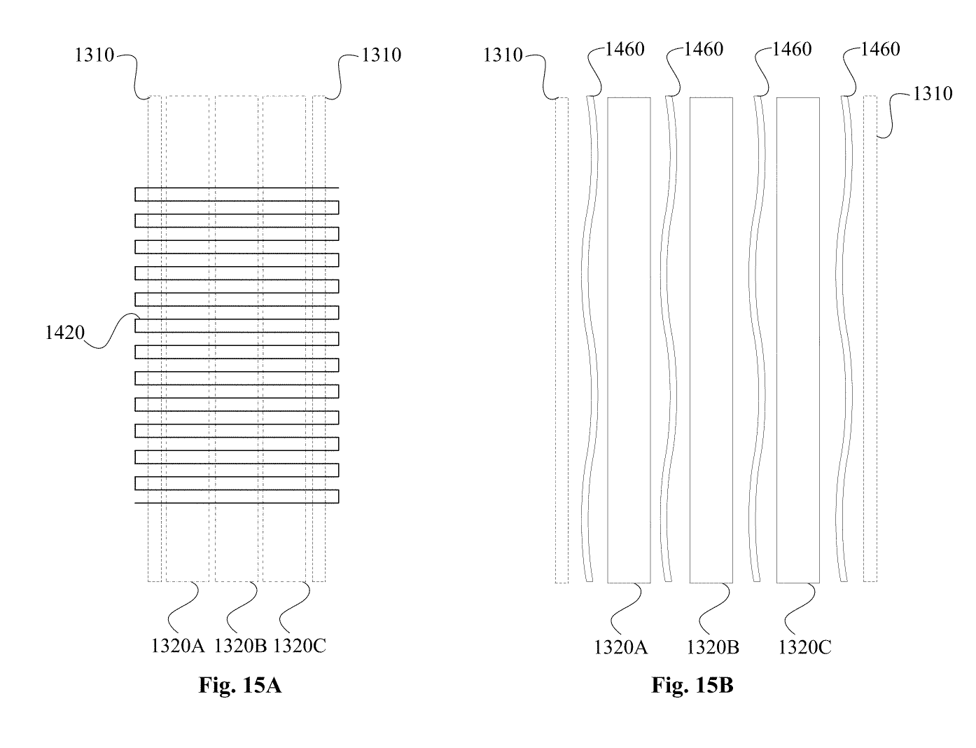

FIGS. 15A and 15B show alternative methods of attaching layers illustrated in FIGS. 14A and 14B, as applied to a shielding device with multiple shielding layers 1320. In FIG. 15A, shielding layers 1320A, 1320B, and 1320C are sandwiched between outer layers 1310, and all layers are stitched together with thread 1420. In FIG. 15B, adhesive layers 1460 are introduced between outer layers 1310 and shielding layers 1320A, 1320B, and 1320C. In other embodiments, a combination of stitching methods, such as one including both stitching and adhesives may be used to attach various layers.

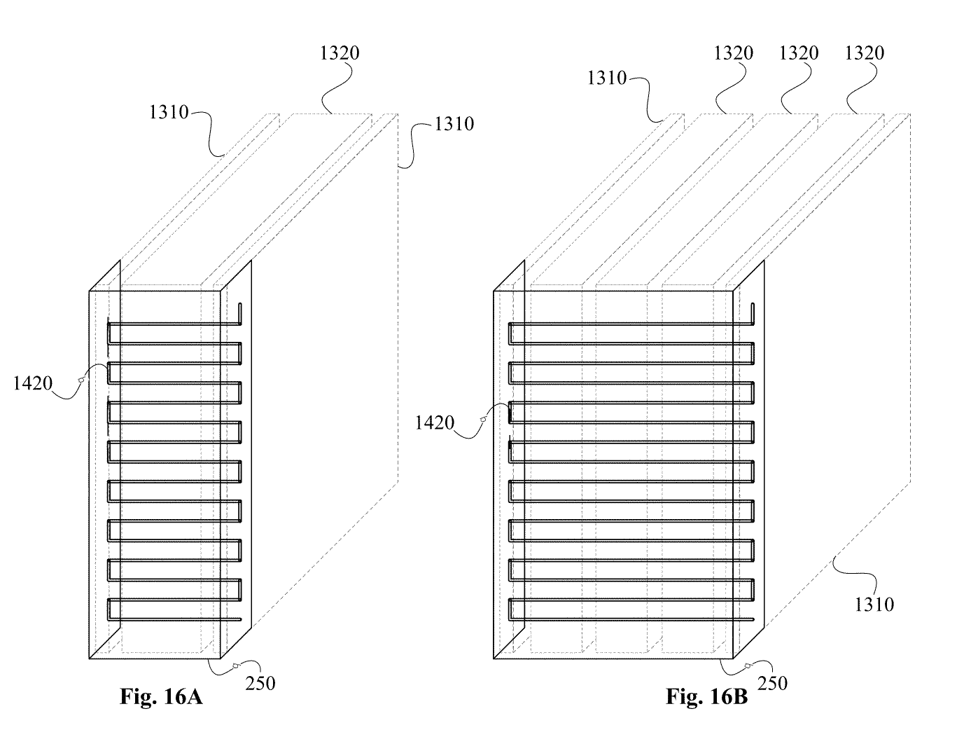

FIGS. 16A and 16B show perspective views of the stitching attachment method at the edge of the shielding device. Here, the edges of layers 1310 and 1320 are covered and held together by a strip of material 250, first illustrated and discussed in FIGS. 2, 4, 5 and accompanying text. In FIG. 16A, the thread pierces strip 250 from the outside, before next piercing layers 1310, 1320, other layer 1310 and emerging through the other side of strip 250. FIG. 16B illustrates a similar approach applied to multiple shielding layers 1320A, 1320B, and 1320C. In the preferred embodiment, strip 250 serves several functions, including a protective function by covering the edges of the various layers, to prevent introduction of contaminants such as water and dust into the shielding device; structural function by holding the edges of the various layers together; another structural function by providing a sturdy material that can hold lengths of thread introduced, for example, by a zig-zag pattern; and a manufacturing function whereby the strip can align the various layers together during construction.

### Applications

Other aspects of the present invention include a number of innovative applications involving various embodiments of the shielding device described herein. The presently disclosed shielding device offers innovative applications for both males and females, ranging from pediatric to adult patients. The shielding device may be used to cover various areas of the human anatomy, shielding them from potentially harmful radiation, while leaving targeted areas exposed to the imaging rays.

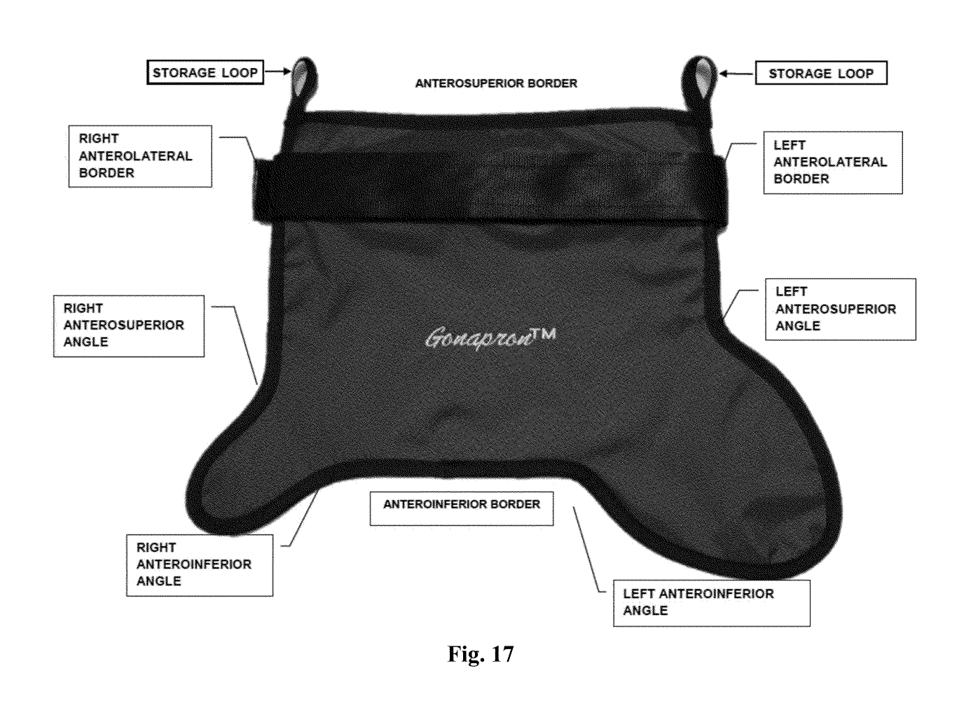

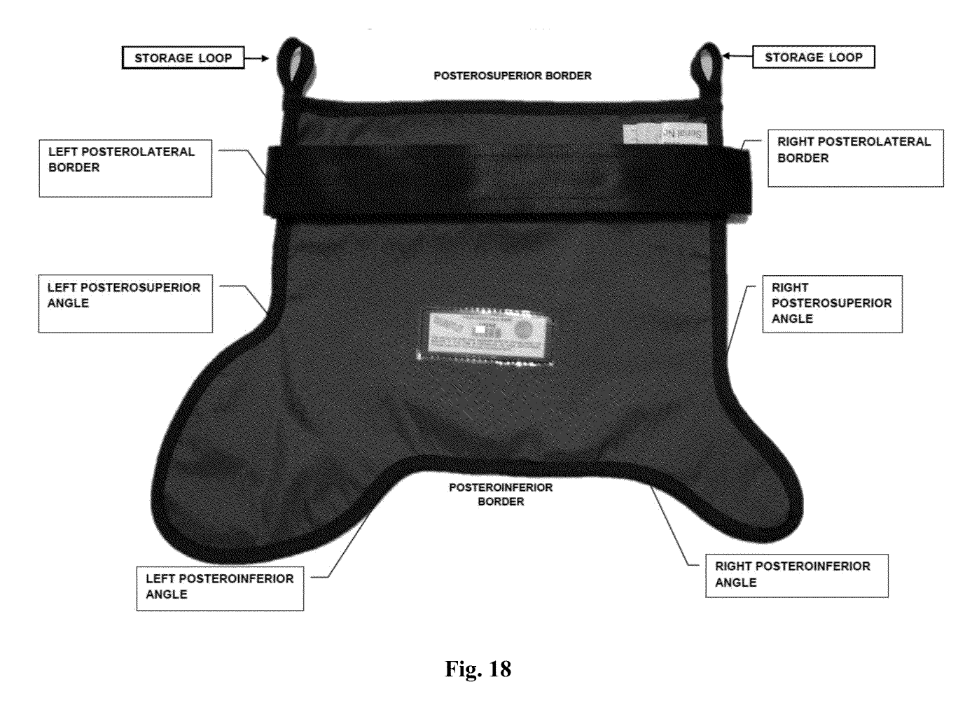

For ease of explanation, FIGS. 17 and 18 provide references to various features of the shielding device. FIG. 17, in an anterior, or front, view of the preferred embodiment of the shielding device, identifies the locations of the right anterolateral border, right anterosuperior angle, right anteroinferior angle, anteroinferior border, left anteroinferior angle, left anterosuperior angle, left anterolateral border, storage loops, and anterosuperior border. FIG. 18, in a posterior view of the preferred embodiment of the shielding device, identifies the locations of the left posterolateral border, left posterosuperior angle, left posteroinferior angle, posteroinferior border, right posteroinferior angle, right posterosuperior angle, right posterolateral border, storage loops, and posterosuperior border.

Innovative applications involving the shielding device disclosed herein include the Supralay Position, the Modified Supralay Position, the Bilasupralay Position, the Male Pediatric Infralay Position, the Adult Infralay Position, and the Modified Infralay Position, among others.

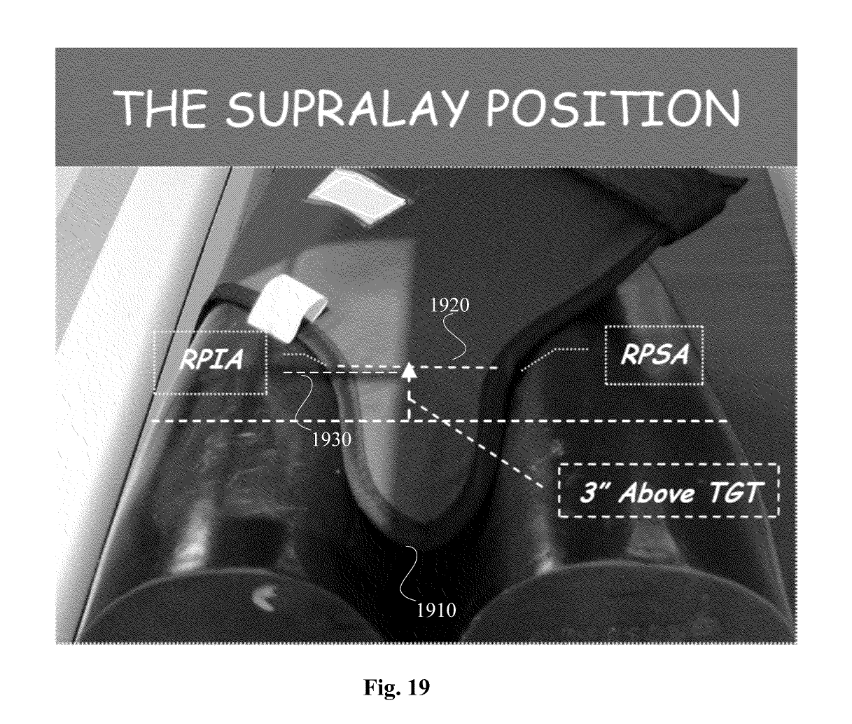

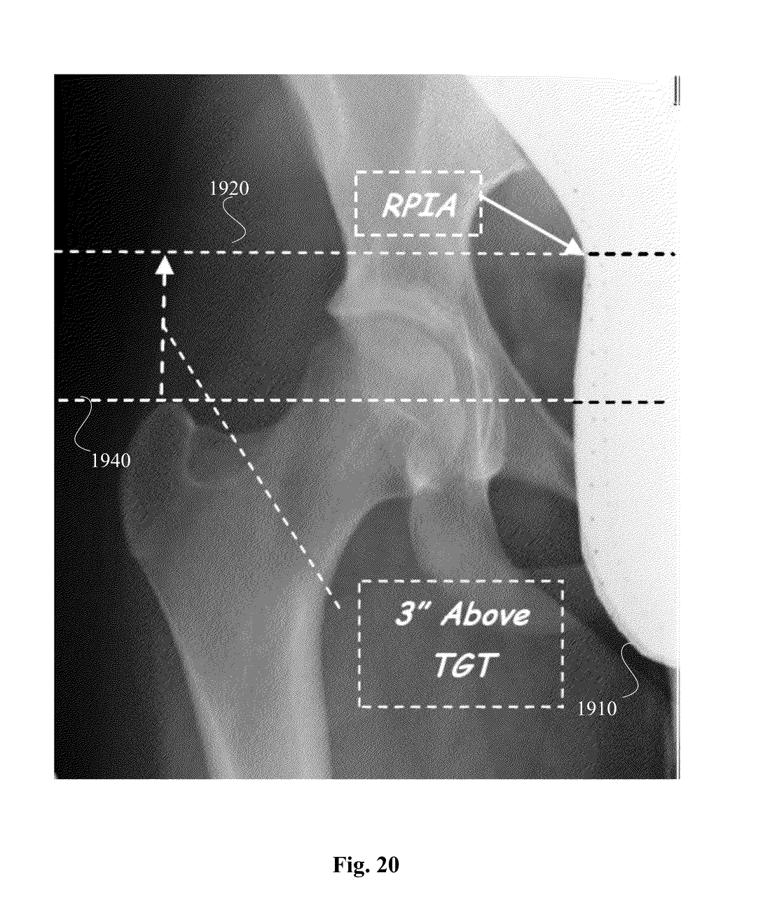

The Supralay Position, illustrated in FIGS. 19 and 20, enables medical imaging of hips of female patients. As illustrated in FIG. 19, the patient is supine, or positioned lying on her back on a medical table, with the right leg inverted medially. The apron's smaller shield 1910 is placed with its tapered end facing inferiorly, or downward from the torso pointing at the patient's feet. As illustrated in FIG. 19, in the Supralay Position, the plane 1920 between the apron's Right Posterosuperior Angle (“RPSA”) and its Right Posteroinferior Angle (“RPIA”) traverses parallel to the lateral centering line 1930 on the collimator light field, at a level of approximately three inches above the Greater Trochanter. One of ordinary skill in the art will understand that patient physiology may dictate deviations from or modifications of dimensions and positioning illustrated above.

FIG. 20 is a sample x-ray image illustrating the use of the apron in the Supralay Position, including the apron's smaller shield 1910, the level of the TGT 1940, and plane 1920. As shown in the figure, the apron provides a clean, unobstructed, view of the right hip, while shielding the female reproductive organs. To obtain an image of the left hip, a mirror image of the positioning described above but with respect to the left leg can be employed.

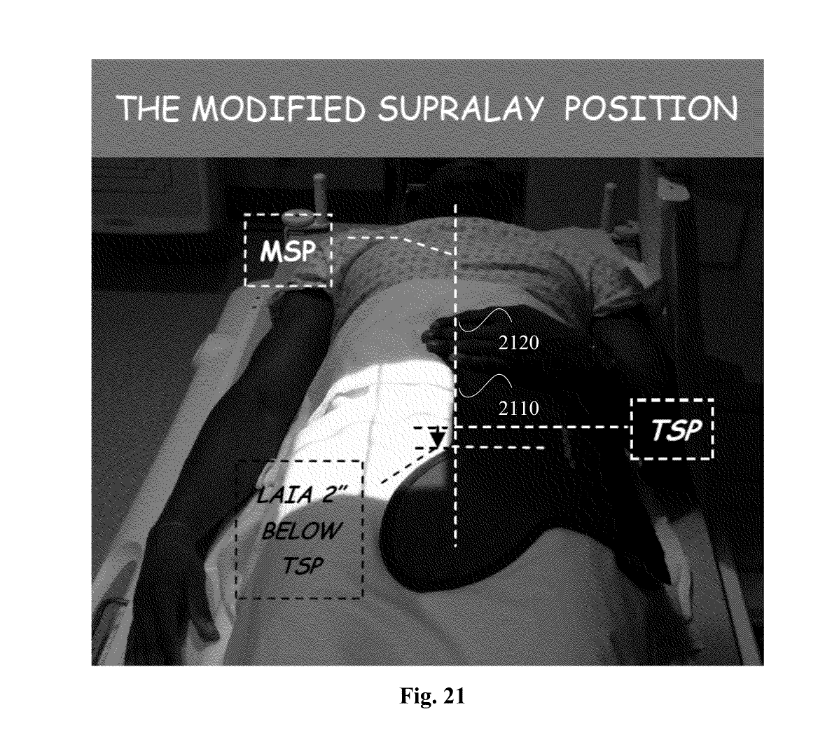

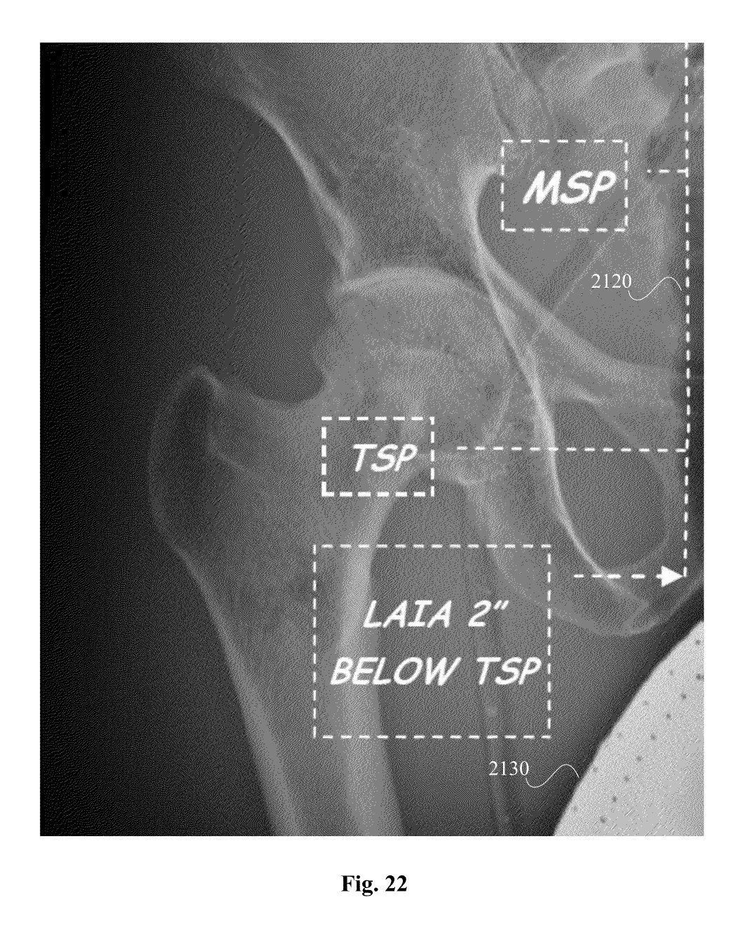

The Modified Supralay Position is illustrated in FIGS. 21 and 22, and can be used to obtain images of hips of male patients. It is beneficial to modify the standard Supralay Position described above when dealing with male patients because male reproductive organs are located differently from female reproductive organs. Consequently, to obtain more complete shielding around the male gonadal area, the Modified Supralay Position is preferably applied. As illustrated in FIG. 21, the patient is supine, or positioned lying on his back on a medical table, with the right leg inverted medially. The apron is placed with its Anteroinferior Border (“AIB”) 2110 on the Midsagittal Plane (“MSP”) 2120, and its Left Anteroinferior Angle (“LAIA”) at a level of approximately two inches below the symphysis pubis (“TSP”). To enhance stability of the apron during imaging, and to avoid possible slippage, the technician may ask the patient to hold the apron during the procedure.

FIG. 22 is a sample x-ray image illustrating the use of the apron in the Modified Supralay Position, including the apron's larger shield 2130 and the MSP 2120. As shown in the figure, the apron provides a clean, unobstructed, view of the right hip, while shielding the male reproductive organs. To obtain an image of the left hip, a mirror image of the positioning described above but with respect to the left leg can be employed.

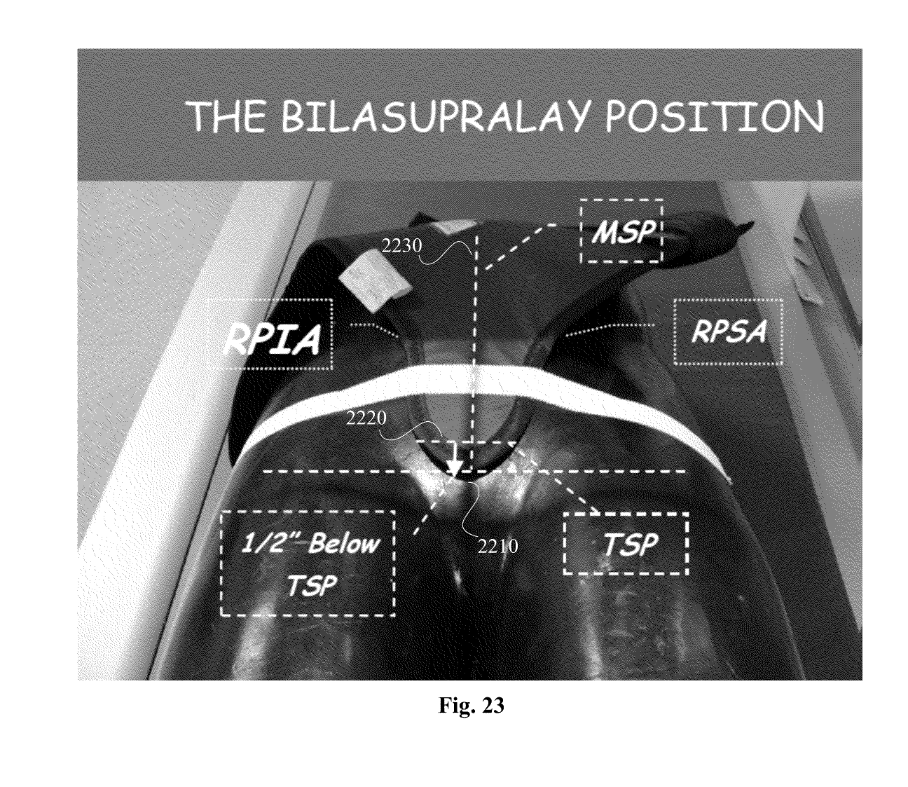

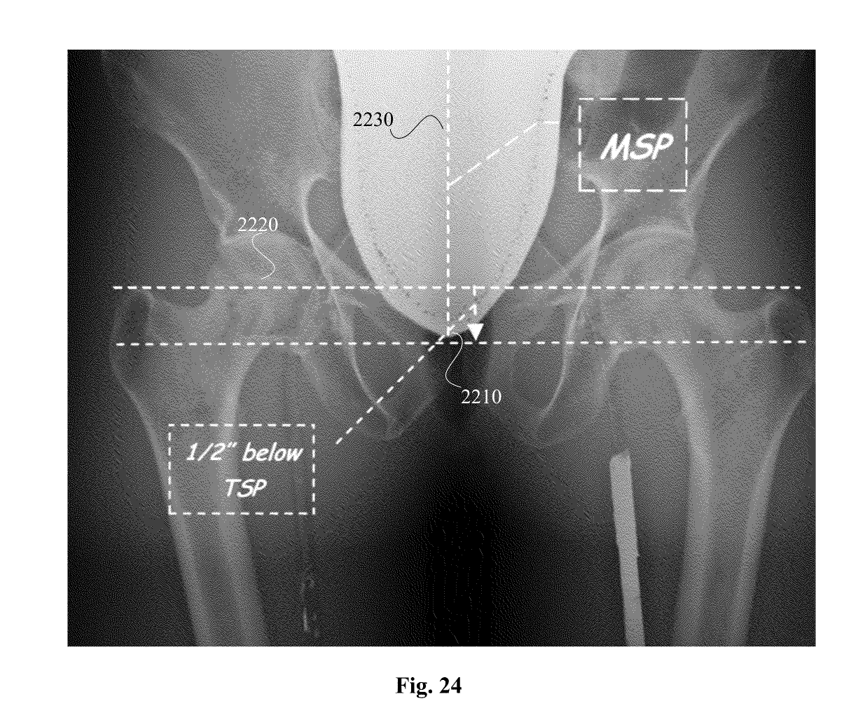

The Bilasupralay Position is illustrated in FIGS. 23 and 24, and can be used to obtain an image of both hips of female patients at the same time, also known as an AP Bilateral Hips view. As illustrated in FIG. 23, the patient is supine, or positioned lying on her back on a medical table, with both legs inverted medially. The apron's smaller gonadal shield is placed with its tapered end 2210 facing inferiorly, or downward from the torso pointing at the patient's feet, wherein the tapered end 2210 is positioned approximately one half inch below The Symphysis Pubis (“TSP”) 2220. The longitudinal centering line 2230 of the collimator light field divides the smaller gonadal shield into approximately equal halves at a midpoint between the Right Posterosuperior Angle (“RPSA”) and the Right Posteroinferior Angle (“RPIA”), and is superimposed over the Midsagittal Plan (“MSP”).

FIG. 24 is a sample x-ray image illustrating the use of the apron in the Bilasupralay Position, including the smaller gonadal shield's tapered end 2210, TSP 2220, and longitudinal centering line 2230. As shown in the figure, the apron provides a clean, unobstructed, view of both hips, while shielding the female reproductive organs.

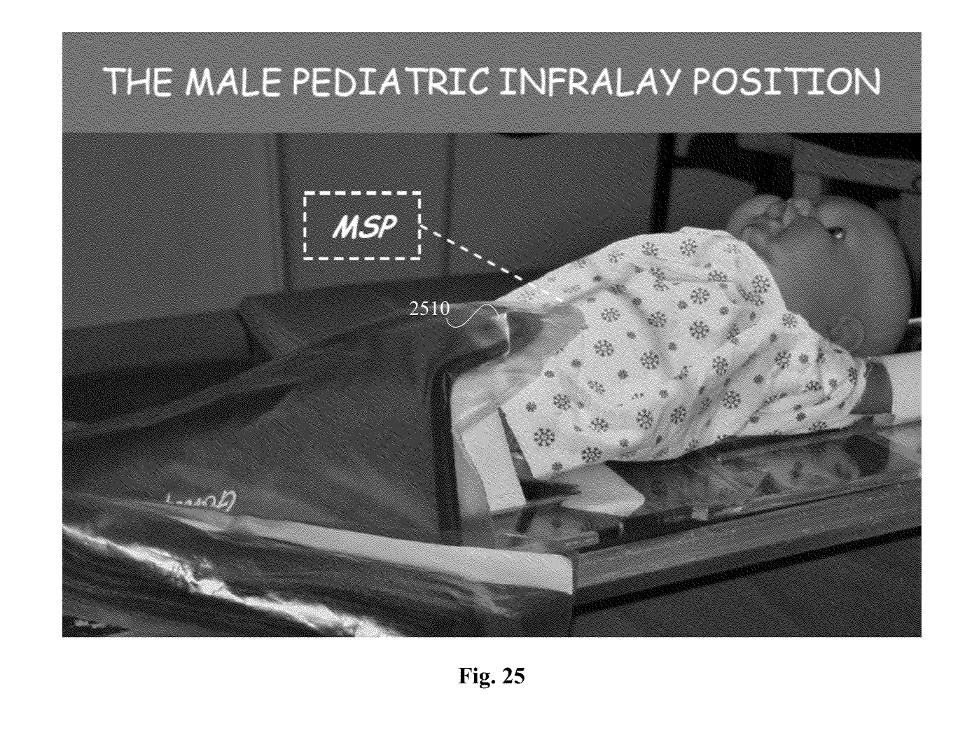

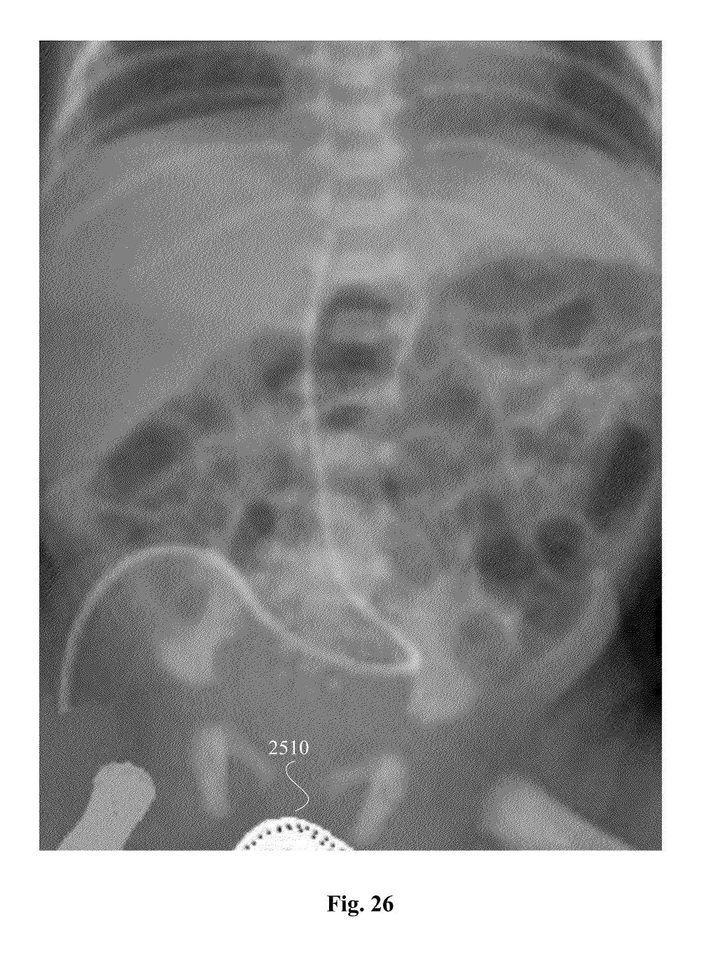

The Male Pediatric Infralay Position is illustrated in FIGS. 25 and 26, and can be used to obtain abdominal images of male pediatric patients. This technique is not preferably applied to female pediatric patients due to the location of the ovaries in the exposed pelvic region. As illustrated in FIG. 25, the patient is supine, or positioned lying on his back on a medical table. The apron's smaller gonadal shield is placed with its tapered end 2510 facing superiorly directly over the testicles, or pointing up from the gonadal area toward the head of the patient. The longitudinal centering line of the collimator light field divides the gonadal shield into approximately equal halves at a midpoint between the Right Anterosuperior Angle (“RASA”) and the Right Anteroinferior Angle (“RAIA”) and is superimposed over the Midsagittal Plane (“MSP”).

FIG. 26 is a sample x-ray image illustrating the use of the apron in the Male Pediatric Infralay Position, including the smaller gonadal shield's tapered end 2510. As shown in the figure, the apron provides a clean, unobstructed, view of the patient's abdomen, while shielding the reproductive organs.

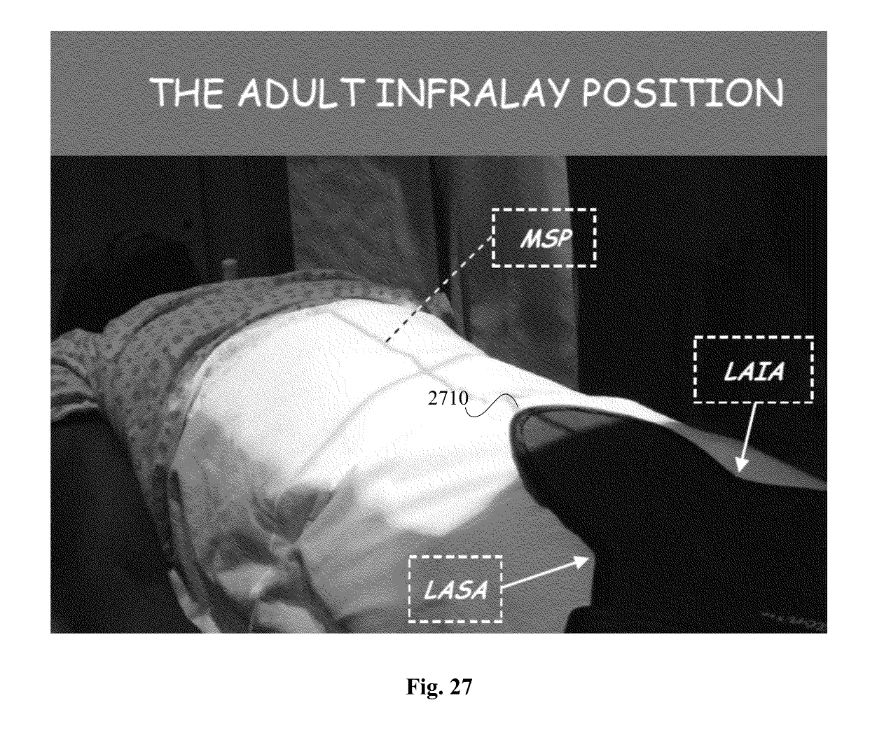

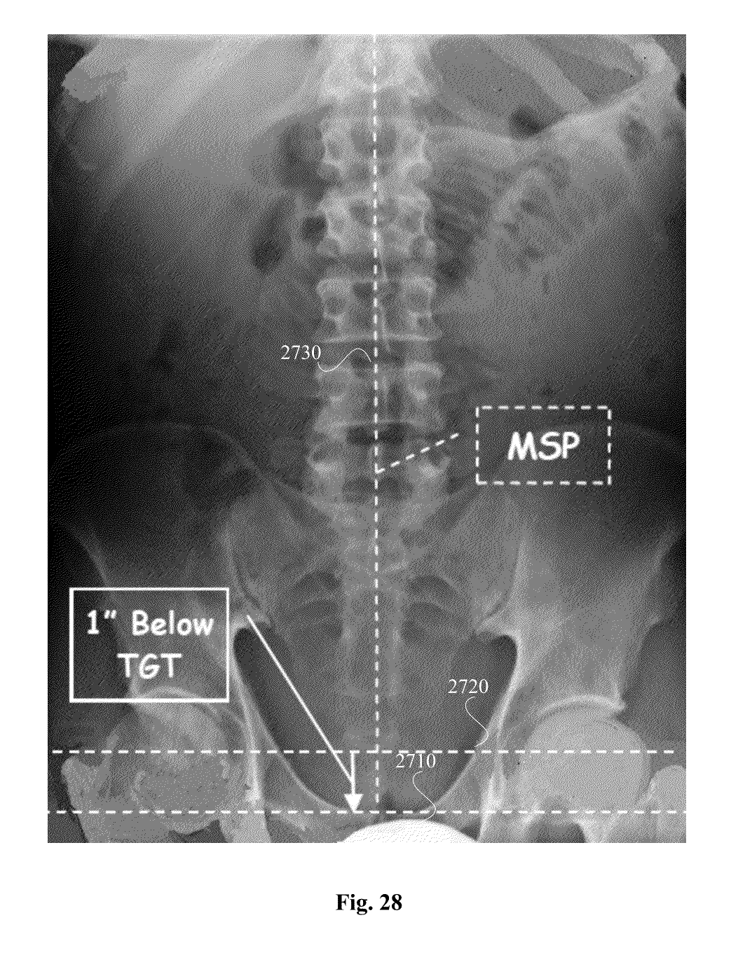

The Adult Infralay Position is illustrated in FIGS. 27 and 28, and can be used to obtain abdominal images of male patients. As illustrated in FIG. 27, the patient is supine, or positioned lying on his back on a medical table, with their knees slightly flexed. The apron's larger gonadal shield is placed with its tapered end 2710 facing superiorly, or upward toward the patient's head, at a level approximately one inch below The Greater Trochanter (“TGT”), which is the level of the symphysis pubis. The longitudinal centering line of the collimator light field divides the gonadal shield into equal halves at a midpoint between the Left Anterosuperior Angle (“LASA”) and the Left Anteroinferior Angle (“LAIA”), and is superimposed over the Midsagittal Plane (“MSP”).

FIG. 28 is a sample x-ray image illustrating the use of the apron in the Adult Infralay Position, including the larger gonadal shield's tapered end 2710, TGT 2720, and longitudinal centering line 2730. As shown in the figure, the apron provides a clean, unobstructed, adult male AP abdomen image, while shielding the reproductive organs.

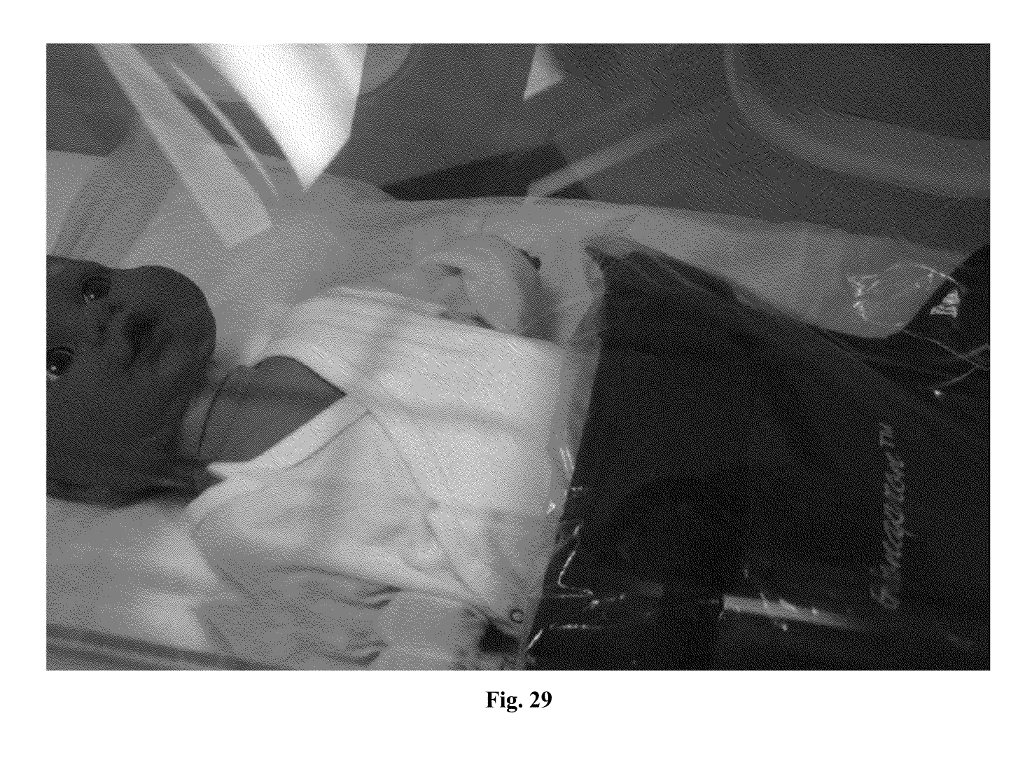

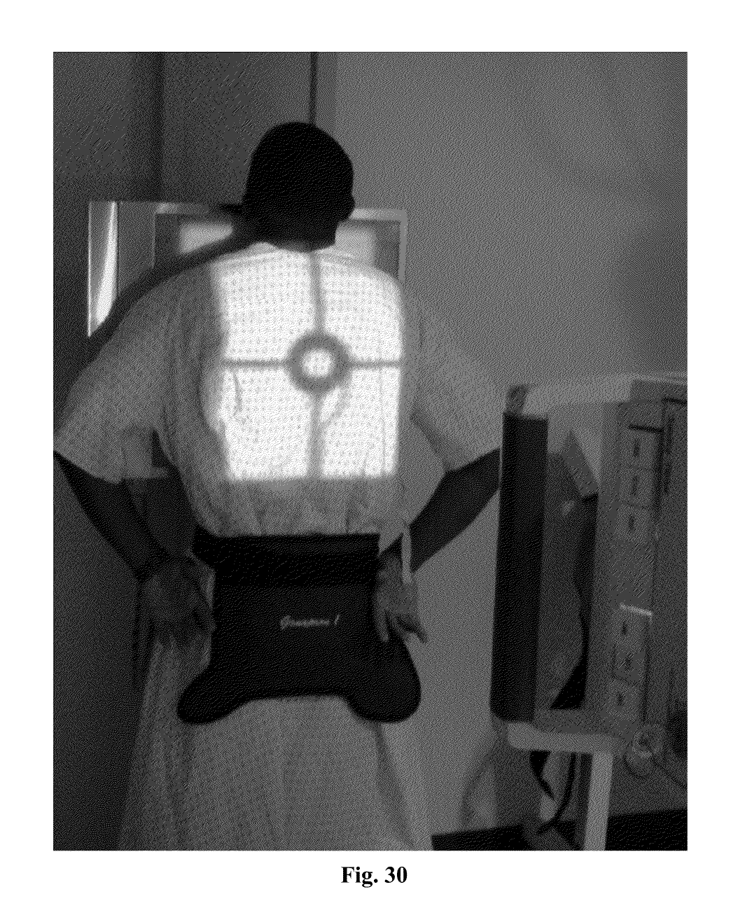

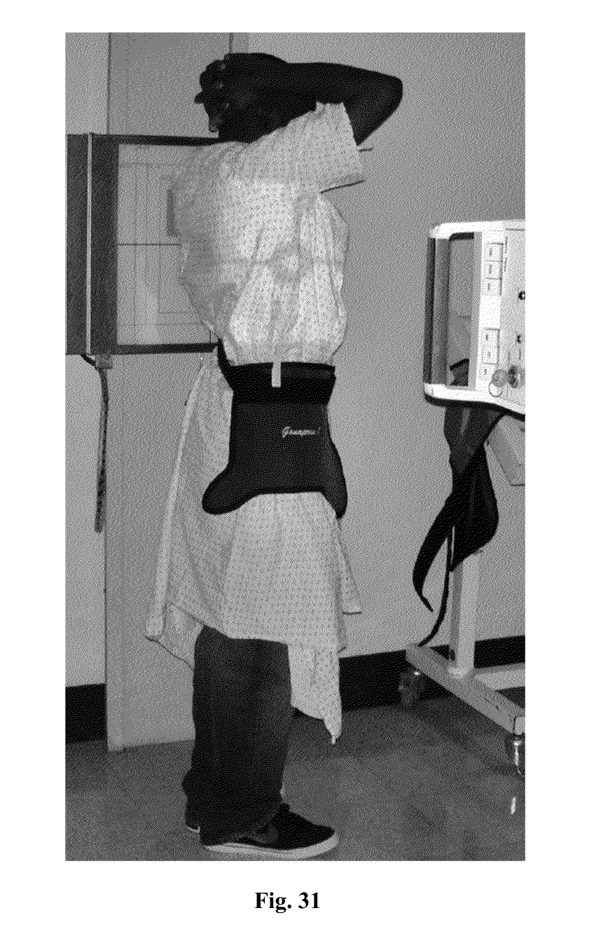

As illustrated in FIGS. 29-31, the apron can also be used as a half-apron for supine pediatric AP chest x-rays (FIG. 29), adult PA x-rays (FIG. 30), and adult lateral chest x-rays (FIG. 31).

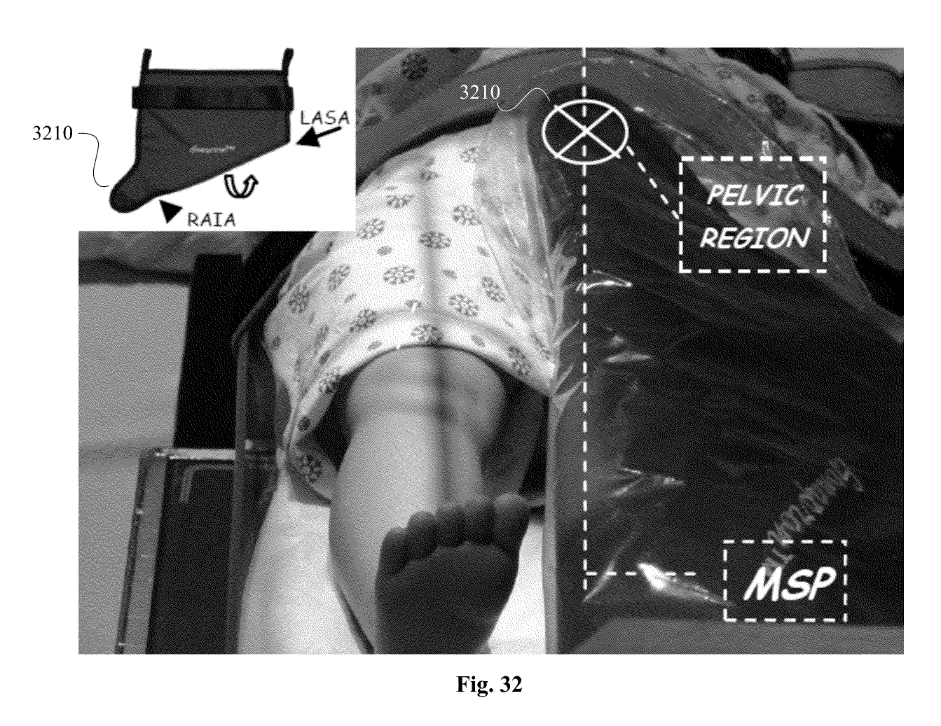

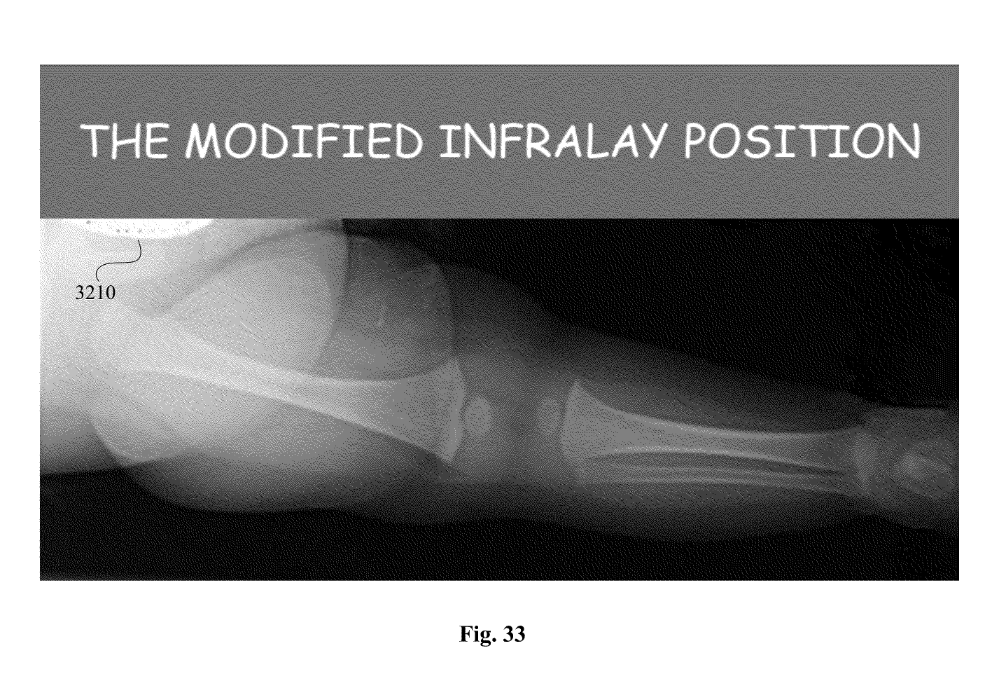

The Modified Infralay Position is illustrated in FIGS. 32 and 33, and can be used to obtain long bone images of pediatric patients. As illustrated in FIG. 32, the patient is supine, or positioned lying on his back on a medical table. In this application, to position the apron, first it is folded posteriorly at the Right Anteroinferior Angle (“RAIA”) and the left Anterosuperior Angle (“LAIA”) to form a straight edge that will lay parallel to the limb and prevent superimposition of the affected extremity and the shielding device. This is illustrated in the cutout in the top left corner of FIG. 32. The smaller gonadal shield is placed with its tapered end 3210 facing superiorly and centered directly over the mid pelvic region where the Midsagittal Plane (“MSP”) divides the gonadal shield into approximately equal left and right halves.

FIG. 33 is a sample x-ray image illustrating the use of the apron in the Modified Infralay Position, including the smaller gonadal shield's tapered end 3210. As shown in the figure, the apron provides a clean, unobstructed, AP pediatric long bone image, while shielding the reproductive organs.

In other embodiments, the radiation shielding device, or apron, described herein can be used to shield other sensitive organs, including the thyroid gland, and breasts. In addition, the apron may be used in a portable setting, where a patient is too ill to make it to the radiology department.

A further enhancement to the radiation shielding device comprises one or more lasers used for positioning and leveling the apron on a patient. The one or more lasers may be permanently attached to the apron in select positions, or they may be temporarily attachable through a fastener such as Velcro. The lasers may assist with measuring the various angles and distances used to position the device, some of which are illustrated in FIGS. 19-33 and described in accompanying text. The lasers should preferably generate a visible line used to align the apron, and may be adjustable in brightness and color. In other embodiments, the lasers may be rotatable around an axis, and where provided, a mechanism may provide the ability to lock the lasers at a certain position and/or angle.

In another embodiment of the present invention, the shielding apron may be placed in an enclosure generally shaped to accept the shielding apron, also referred to as an apron bag herein. In this embodiment, the enclosure may be made from a plastic material to provide transparency for accurate placement of the shielding apron. The enclosure may be disposable to provide a sanitary shielding apron. In other embodiments, the enclosure may be reusable, which may require the bag to be cleaned periodically, or the enclosure may be disposable to decrease maintenance times and increase patient confidence in the cleanliness of the shielding apron. Moreover, the enclosure may be covered with an antibacterial substance to curtail the collection of harmful bacteria and to prevent transmission of illnesses from one patient to another.

The foregoing description of the various and preferred embodiments of the present invention has been presented for purposes of illustration and explanation. It is not intended to be exhaustive nor to limit the invention to the specifically disclosed embodiments. The embodiments herein were chosen and described in order to explain the principles of the invention and its practical applications, thereby enabling others skilled in the art to understand and practice the invention. However, many modifications and variations will be apparent to those skilled in the art, and are intended to fall within the scope of the invention, claimed as follows.

What is claimed is:

1. A radiation shielding device comprising:
one or more interior shielding layers, wherein the one or more interior shielding layers comprise at least one radiation attenuation material, and wherein the one or more interior shielding layers comprise a body having at least two extending members;
two exterior encasing layers having a substantially similar shape as the one or more interior shielding layers; and
a strap configured to attach the shielding device to a patient;
wherein the one or more interior shielding layers are positioned between the two exterior encasing layers, and wherein the one or more interior shielding layers are attached to the exterior encasing layers at the exterior edge of the layers.

2. The radiation shielding device of claim 1, further comprising one or more loops attached to the radiation shielding device.

3. The radiation shielding device of claim 1, further comprising a strip of material wrapped around the edge of the radiation shielding device.

4. The radiation shielding device of claim 3, further comprising a thread attaching the strip of material to the exterior encasing layers and to the one or more interior shielding layers.

5. The radiation shielding device of claim 1, wherein the at least one radiation attenuation material comprises a polymer.

6. The radiation shielding device of claim 5, wherein the at least one radiation attenuation material further comprises a metallic powder distributed throughout the polymer.

7. The radiation shielding device of claim 6, wherein the exterior encasing layers and the one or more interior shielding layers are flexible.

8. The radiation shielding device of claim 7, wherein the one or more radiation shielding layers are 0.5 mm lead equivalent.

9. A method of manufacturing a radiation shielding device, the method comprising:
providing one or more interior shielding layers, wherein the one or more interior shielding layers comprise at least one radiation attenuation material, and wherein the one or more interior shielding layers comprise a body having at least two extending members;
providing two exterior encasing layers having a substantially similar shape as the one or more interior shielding layers;
placing the one or more interior shielding layers between the two exterior encasing layers; and
attaching the one or more interior shielding layers to the two exterior encasing layers at the edge of the layers to form the radiation shielding device.

10. The method of claim 9, further comprising:
providing a strap configured to attach the shielding device to a patient; and
attaching the strap to the one or more interior shielding layers and at least one of the exterior encasing layers.

11. The method of claim 9, wherein attaching the one or more interior shielding layers to the two exterior encasing layers at the edge of the layers comprises stitching the layers together.

12. The method of claim 9, wherein providing one or more interior shielding layers comprises dispersing a metallic powder throughout a polymer.

13. The method of claim 9, further comprising:
exposing the radiation shielding device to ionizing radiation; and
examining the radiation shielding device for defects.

14. A method for shielding a patient from radiation emitted by a medical imaging apparatus, the method comprising:
providing a radiation shielding device, wherein the radiation shielding device comprises one or more interior shielding layers and two exterior encasing layers having a substantially similar shape as the one or more interior shielding layers, wherein the one or more interior shielding layers comprise at least one radiation attenuation material, and wherein the one or more interior shielding layers comprise a body having at least two extending members;
positioning the patient relative to the medical imaging apparatus; and
positioning a portion of the radiation shielding device over a portion of the patient's body prior to activating the medical imaging apparatus.

15. The method of claim 14, wherein one of the at least two extending members of the radiation shielding device is smaller than the other extending member.

16. The method of claim 15, wherein the patient is a pediatric patient, and positioning a portion of the radiation shielding device over a portion of the patient's body comprises positioning the smaller extending member over the patient's gonadal area.

17. The method of claim 16, further comprising enclosing the radiation shielding device in an antibacterial bag shaped to accept the radiation shielding device.

18. The method of claim 15, wherein the patient is an adult patient, and positioning a portion of the radiation shielding device over a portion of the patient's body comprises positioning the larger extending member over the patient's gonadal area.

19. The method of claim 14, wherein the radiation shielding device comprises a substantially rectangular portion, and positioning a portion of the radiation shielding device over a portion of the patient's body comprises positioning the substantially rectangular portion over the lower portion of the patient's torso.

20. The method of claim 14, wherein the radiation shielding device comprises a strap, and the method further comprises attaching the radiation shielding device to the patient by wrapping the strap around the patient's waist.
